(19) United States
(12) Patent Application Publication
(10) Pub. No.: US 2024/0291899 A1
(43) Pub. Date: Aug. 29, 2024

(54) CONTEXT BASED ACCESS CONTROL, PRIVACY CONTROL AND DATA PROTECTION FOR AN ONLINE SOCIAL NETWORK

(71) Applicant: VIRTUAL ARTIFACTS INC., Montréal (CA)

(72) Inventor: Jean Dobey OUREGA, Verdun (CA)

(21) Appl. No.: 18/652,389

(22) Filed: May 1, 2024

Related U.S. Application Data
(63) Continuation of application No. 17/156,180, filed on Jan. 22, 2021, now abandoned.
Application No. 17/156,180 is a continuation of application No. 15/699,699, filed on Sep. 8, 2017, now abandoned.
Application No. 15/699,699 is a continuation of application No. 13/783,815, filed on Mar. 4, 2013, now abandoned.
Application No. 13/783,815 is a continuation-in-part of application No. 12/411,588, filed on Mar. 26, 2009, now abandoned.
Application No. 12/411,588 is a continuation of application No. 12/477,650, filed on Jun. 4, 2009, now abandoned.

(51) Int. Cl. H04L 67/50; G06F 16/958; G06Q 10/107; G06Q 50/00

(52) U.S. Cl. CPC H04L 67/535; G06F 16/958; G06Q 10/107; G06Q 50/01

(57) ABSTRACT

Embodiments of systems and methods for context based access control, privacy control, and data protection for an online social network are disclosed. In some embodiments, upon receipt of a request for access to a requested context, access is granted when access control information for the requested context associates the requesting party with the context owner of the requested context. Access control information for the requested context associated to a first party is accessible to the requesting party when there exists a context owned by the first party in which the relationship information associates the first party with the requesting party and the first party with the context owner of the requested context and there exists a context owned by the requesting party in which relationship information associates the requesting party with the first party and the requesting party with the context owner of the requested context.

### CROSS-REFERENCE TO RELATED APPLICATION

This application is a continuation of U.S. patent application Ser. No. 17/156,180, filed Jan. 22, 2021, which is a continuation of U.S. patent application Ser. No. 15/699,699, filed Sep. 8, 2017, which is a continuation of U.S. patent application Ser. No. 13/783,815, filed Mar. 4, 2013, which is a continuation-in-part of U.S. patent application Ser. No. 12/411,588, filed Mar. 26, 2009, and a continuation of U.S. patent application Ser. No. 12/477,650, filed Jun. 4, 2009. The disclosures of these prior applications are hereby incorporated by reference in their entireties.

### TECHNICAL FIELD

This description relates generally to social networks, and more precisely, to computer-implemented methods and systems for building, managing and sharing a digital identity of a user over a social network.

### BACKGROUND

Computer mediated social interaction and networking was suggested early on. There were many early efforts to support social networks via computer-mediated communication.

However, during online sessions, users may not properly perceive risks taken when sharing information about themselves or about their environment. Online sessions bring an entirely different meaning to friendships and relationships.

Considering the above issues, one should realize that they are normally inexistent in the real world. In fact, privacy, image management and material interactions are present in our everyday “real world” life and are often taken for granted. The same cannot be said concerning our “computer mediated social” life.

This problem is addressed at least in part in by the present invention.

### SUMMARY

A first aspect of the present invention is directed to a computer implemented method for establishing, managing and displaying contextual information from a plurality of contexts. The method comprises storing the contextual information for a plurality of parties. The contextual information, for each of the plurality of contexts, comprises a party identity that indicates a corresponding context owner and relationship information that associates the context owner with at least another party from the plurality of parties. The method also comprises, upon receipt of a request for access, by a requesting party from the plurality of parties, to contextual information from at least one requested context from the plurality of contexts, applying a context accessibility rule whereby the requested context is accessible to the requesting party when a corresponding relationship information from the requested context associates the requesting party with a corresponding context owner of the requested context. The method then comprises, when the context accessibility rule is met, applying a private relationship accessibility rule. The corresponding relationship information from the requested context associated to a first party of the plurality of parties is accessible to the requesting party when:
(i) there exists at least one context from the plurality of contexts owned by the first party in which the relationship information associates the first party with the requesting party and the first party with the context owner of the requested context; and
(ii) there exists at least one context from the plurality of contexts owned by the requesting party in which relationship information associates the requesting party with the first party and the requesting party with the context owner of the requested context.

Optionally, the contextual information from the requested context further may comprise content owned by at least a second party from the plurality of parties and wherein, when the context accessibility rule is met, and the method may further comprise applying a private content visibility rule whereby the content from the requested context associated to the second party is accessible to the requesting party when the corresponding relationship information from the requested context associated to the second party is accessible to the requesting party. The content from the requested context associated to the second party may further be a child content in a chain of dependent contents, the child content from the requested context associated to the second party being accessible to the requesting party when each of the dependent contents in the chain is accessible to the requesting party. At least the content associated to the first party may yet further be associated to a further context from the plurality of contexts.

The method may yet optionally further comprise applying a private identity visibility rule wherein the party identity from the contextual information of the requested context is accessible to the requesting party when the requested context is accessible to the requesting party.

As additional options, each of the plurality of contexts may be a representation of an environment with which at least one of the plurality of parties interacts and that is shared with other parties of the plurality of parties. A unique identifier may be provided for each of the plurality of contexts, the unique identifier being one of auto-generated or uniquely defined by the context owner of the corresponding context. The relationship information for each of the plurality of contexts may be a list of parties from the plurality of parties that are associated thereto. The content from the first party may be one of a photo, a video, a file, a text, or an aggregation thereof.

A second aspect of the present invention is directed to a system for establishing, managing and displaying contextual information from a plurality of contexts. The system comprises a database module, a context accessibility module and a relationship accessibility module. The database module is for storing the contextual information for a plurality of parties. The contextual information, for each of the plurality of contexts, comprises a party identity that indicates a corresponding context owner and relationship information that associates the context owner with at least another party from the plurality of parties.

The context accessibility module is for, upon receipt of a request for access, by a requesting party from the plurality of parties, to contextual information from at least one requested context from the plurality of contexts, applying a context accessibility rule whereby the requested context is accessible to the requesting party when a corresponding relationship information from the requested context associates the requesting party with a corresponding context owner of the requested context.

The relationship accessibility module is for, when the context accessibility rule is met, applying a private relationship accessibility rule whereby the corresponding relationship information from the requested context associated to a first party of the plurality of parties is accessible to the requesting party when:
(i) there exists at least one context from the plurality of contexts owned by the first party in which the relationship information associates the first party with the requesting party and the first party with the context owner of the requested context; and
(ii) there exists at least one context from the plurality of contexts owned by the requesting party in which relationship information associates the requesting party with the first party and the requesting party with the context owner of the requested context.

Optionally, the contextual information from the requested context may further comprise content, stored in the database module, owned by at least a second party from the plurality of parties and the system may further comprise a content visibility module for, when the context accessibility rule is met, applying a private content visibility rule whereby the content from the requested context associated to the second party is accessible to the requesting party when the corresponding relationship information from the requested context associated to the second party is accessible to the requesting party. The content from the requested context associated to the second party may further optionally be a child content in a chain of dependent contents, the child content from the requested context associated to the second party being accessible to the requesting party when each of the dependent contents in the chain is accessible to the requesting party. At least the content associated to the first party may further be associated to a further context from the plurality of contexts

The system may further comprise an identity visibility module for applying a private identity visibility rule wherein the party identity from the contextual information of the requested context is accessible to the requesting party when the requested context is accessible to the requesting party.

As additional options, each of the plurality of contexts is a representation of an environment with which at least one of the plurality of parties interacts and that is shared with other parties of the plurality of parties. A unique identifier may be stored in the database module for each of the plurality of contexts, the unique identifier being one of auto-generated or uniquely defined by the context owner of the corresponding context. The relationship information for each of the plurality of contexts may further be a list of parties from the plurality of parties that are associated thereto. The content from the first party may further be one of a photo, a video, a file, a text, or an aggregation thereof.

### BRIEF DESCRIPTION OF THE DRAWINGS

Further features and advantages of the present invention will become apparent from the following detailed description, taken in combination with the appended drawings, in which:

FIG. 1 is a flow chart which shows an embodiment of a method for building a digital identity of a user over a social network;

FIG. 2 is a flow chart which shows an embodiment of a method for sharing a digital identity of a user over a social network;

FIG. 3 is a flow chart which shows an embodiment of a method for generating a biography associated with a user over a social network;

FIG. 4 is a bloc diagram which shows an embodiment of a system for building a digital identity of a user over a social network;

FIG. 5 is a bloc diagram which shows an embodiment of a system for sharing a digital identity of a user over a social network;

FIG. 6 is a bloc diagram which shows an embodiment of a system for generating a biography associated with a user over a social network;

FIG. 7 illustrates an overview of various parts of a multi-facet system;

FIG. 8 illustrates an overview of a digital identity building module

FIG. 9 illustrates an overview of facet creation & management

FIG. 10 illustrates an overview of facet features;

FIG. 11 illustrates an overview of a system access control;

FIG. 12A) and B) illustrate personal relationships mapping based on facets; and

FIG. 13 illustrates collaborative relationships mapping based on facts.

FIG. 14 is a bloc diagram which shows an embodiment of a system for customizing a relationship between members of a social network based on a multi-facet member profile;

FIG. 15 is a bloc diagram which shows an embodiment of a system for managing sharing of information over a social network;

FIG. 16 is a flowchart which shows a first embodiment of a method for customizing a relationship between members of a social network based on a multi-facet member profile;

FIG. 17 is a flowchart which shows a second embodiment of a method for customizing a relationship between members of a social network based on a multi-facet member profile;

FIG. 18 is a flowchart which shows a third embodiment of a method for customizing a relationship between members of a social network based on a multi-facet member profile;

FIG. 19 is a flowchart which shows a fourth embodiment of a method for customizing a relationship between members of a social network based on a multi-facet member profile; and

FIG. 20 is a flowchart which shows a fifth embodiment of method for customizing a relationship between members of a social network based on a multi-facet member profile;

FIG. 21 is a flowchart which shows a sixth embodiment of method for customizing a relationship between members of a social network based on a multi-facet member profile;

FIG. 22 illustrates a relationship framework in accordance with one embodiment of the present invention;

FIG. 23 is an example of relationship customization in accordance with one embodiment of the present invention;

FIG. 24 is an exemplary flow chart in accordance with one embodiment of the present invention; and

FIG. 25 is an exemplary modular representation of a system in accordance with one embodiment of the present invention.

It will be noted that throughout the appended drawings, like features are identified by like reference numerals. Elements are not drawn to scale.

### DETAILED DESCRIPTION

As mentioned earlier, computer mediated social interaction and networking was suggested early on. There were many early efforts to support social networks via computer-mediated communication.

Early social networking websites were launched in the mid-90s. Some were focusing on ties with former school mates, while others were focusing on indirect ties. User profiles could be created, messages sent to users held on a “friends list” and other members could be sought out who had similar interests to yours in their profiles.

By the end of the 90s, trust-based and friendship-based concepts of social networking emerged. Innovations included not only showing who is “friends” with whom, but giving users more control over content and connectivity.

Between 2002 and 2004, social networking sites became part of mainstream users worldwide. Major players included Friendster, MySpace, Bebo, and Facebook. Facebook is today the most popular social network, and claims over 200 million registered users worldwide.

Various social networking sites have sprung up catering to different languages and countries. It is estimated that combined there are now over 200 social networking sites using these existing and emerging social networking models, without counting the niche social networks (also referred to as vertical social networks) made possible by services such as Ning.

Social networks have always been criticized for being too loose with the information provided by the members. The wealth of this information attracts profilers from various industries.

It has become increasingly common for colleges and universities to use Facebook to investigate violations of campus policies. Students who violate these policies may be discovered through photographs of illicit behavior, membership in groups, or simply information posted on the Facebook website.

Students, angered by the monitoring, have begun to submit “red herring” party listings

In addition, 10 percent of admissions officers from prestigious schools said they had peeked at sites like Facebook and MySpace to evaluate college-bound seniors. Of those using the profiles, 38 percent said it had a “negative impact” on the applicant, according to Kaplan Inc., the education services company that polled the officers.

Employers are increasingly scouring the Internet for “digital dirt” to help them weed through job candidates. In fact, 83.2 percent of recruiters admitted to using online search engines in 2007 to uncover information about candidates, according to Execunet. Of these recruiters, 43 percent admitted to eliminating candidates based on the negative information they found.

As the number of job seekers continues to increase and the pressure to reduce costs continues, companies seek alternatives to paid background checks leading to the appearance of sites specializing in “social reference checks” that will make a background check on an employee through social networks.

Official organizations do try to prevent users that once online their information is extremely hard to remove. These privacy issues are becoming so large that a new business model was born: Reputation Guardians. Companies such as ReputationDefender target teenagers' parents by offering monitoring services of their children social behavior.

Even CNN pushed a story on office/Facebook relationships in January 2009 advising that “you should be monitoring your online content as though your current and future boss can see it, even if they aren't on your buddy list.”

Current social networks are basing their revenue stream on advertising and data sharing. Both models imply the spreading of information that could be considered private.

Patents are even being filed that shows methods of identifying the influential elements within social networks in order to push targeted ads. The first of the pack is Google with its profiling capabilities over a vast amount of sites.

Every day more resources become available to the social network users to warn them about the privacy problems they can encounter if they are not careful about their personal information.

In 2009, in an effort to increase awareness of the online privacy issues, the US House of Representatives, following the European Council, has approved Bill H. RES.31 declaring January 28th, a National Data Privacy Day.

With all these facts, it is hard to believe that social network users are not aware of the potential consequences of their actions. A Rubicon survey, however, still shows that a high number of users would feel embarrassed if part of their profile would become known to some people.

Another study claims that: 43% of adults think it would be pretty easy for someone to find out who they are from their profile; 23% of teens say it would be pretty easy; 33% of adults with profiles think that they would have to work at it, but that someone could eventually find out who they are; 40% of teens say the same; 20% of adults think that it would be difficult for someone to find out who they are; 36% of teens say it would be difficult for someone to find out who they are.

It is clear from these numbers that the perception of privacy differs as one grows older. Furthermore, it strongly suggests that all the industry warnings do not reach the target audience.

Even if they learned about the risks, their options are often limited to the poor and complex settings offered by their favorite sites. The other alternative is to create additional profiles on these networks.

24% of users that have multiple social network accounts do so to either separate their personal from their professional life or to represent a different aspect of their personality.

These users are sharing information because they do not have easy access to preemptive information on social networks, and do not possess the tools that would give them the benefits of sharing with the privacy and the security to protect their future.

On the surface, social network users advance that their primary reason of using such tool is to keep in touch with their close friends. However, when one looks at the deeper significance of social networks one realizes that social networks are a crucial element to help anyone trying to define himself and to gain self-confidence.

It is important to understand that a user will always organize his social environment by priority. Below is an example of such perceived audience from the closest relationships to the furthest.

Each social user attributes an importance to the feedback he obtains from each of these groups. Hence, a positive feedback from a friend will be significantly more self-fulfilling than one from a professor.

It is important for the user to receive feedback concerning the elements that define him. Social sites typically focus on such aspects.

When looking at the various elements that define today's youth, we realize that materialist behavior is not only important but also growing. Surprisingly enough, social networks have always steered away from using social objects for identity purposes trying instead to use them for shopping activities. According to a warning given to the Annual Meeting of the Royal College of Psychiatrists (U.K.), reported by Snugd, the Facebook Generation who use internet for everything and who have never known a world unless they surf on-line are growing up with a dangerous view of the world and their own identity. They are going through major identity crisis. People who born after 1990 have grown up in a world dominated by online social networks such as Facebook and MySpace.

Many of these youngsters use Internet as the main medium to communicate. Their relationships are quickly disposed at the click of a mouse. Because of the online social networking, people find the real world boring and unstimulating. These interactions between people in the digital realm reduced sensory experience; person's expression/body language/voice/tone aren't there; and this can shape one's perceptions of such an interaction differently.

Online session changes the perception to an unreal, fantastic or imagery, dreamlike state, and this unnatural blending of mind with the other person leads to entirely different meaning to friendships and relationships. Because of this online mess, youngsters are going through the stages of vulnerable to impulsive to suicide.

The lack of feedback for material possessions in social networks creates an important void in the road for stronger self-esteem. Without that relation placed in the context of each perceived audience, a social user can never feel as complete online as in real life.

When considering the above issues one should realize that they are normally inexistent in the real world. In fact, privacy, image management and material interactions are present in our everyday life that they are often taken for granted.

Without the natural rules of social interactions, technology will use online relationships for capital gain at the detriment of the interlocutors.

Some embodiments based on the present teachings aim at providing solutions for users who desire to build a digital identity over a social network based at least in part on elements of their environment (also referred herein as social objects). It also aims at providing solutions for users who desire to partition their identity over social networks into a plurality of subset-identities (also referred herein as facets) in order to be able to customize privacy rules for each one of the their facets. For a given user or a group of users, may for instance enable users to hide one or more facets while providing access to one or more other facets. This way they can manage their images and control the impressions other people form of them. Some embodiments based on the present teachings also aim at providing solutions for building a biography based on social objects.

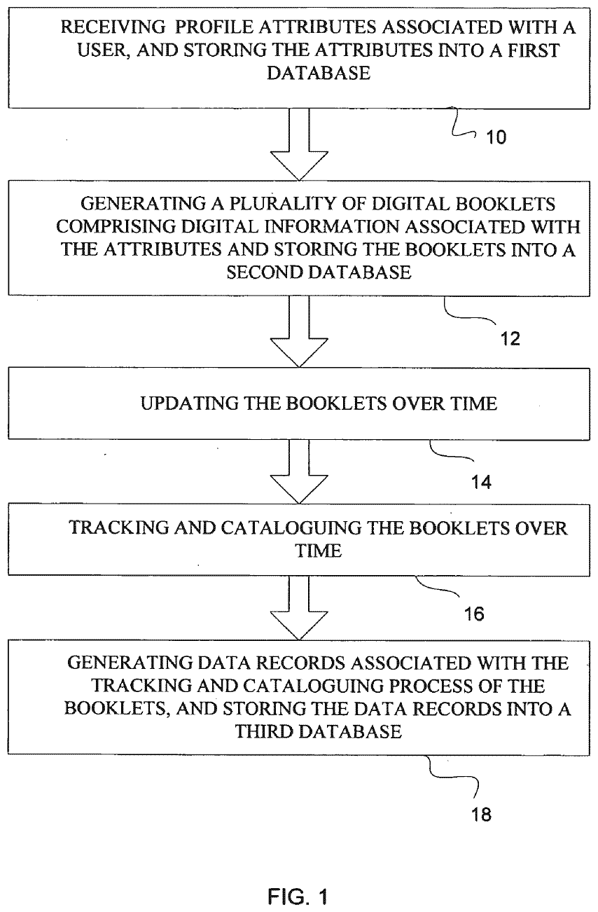

A first set of exemplary embodiments will be described with particular reference to FIGS. 1 to 13.

Hibe is a social utility platform that let users (individual or corporate entity) build an online presence.

First, Hibe let users create a social environment, along with elements that define them (their identity) and people they interact with in real life. Second, Hibe let users create various social contexts (for different purposes) as a subset of their social environment.

Elements of a user social environment in the digital realm are represented by Booklets: digital symbols through which they track their life experience and interactions with others over time, in the context of these elements. The user's life experience and interactions with each element are represented within the booklet by factual events, textual posts, and multimedia content (photos, videos, sound) associated with such an element. Users can create booklets just about everything in their social environment, including people, animals, products & things, places, interests & causes, etc.

Users can then associate a subset of booklets (that define them or the image they want to portrait) and people (they want to interact with) within each social context (aka Facet), depending on the purpose of this social context. Thus, with Hibe, users can mimic their everyday life experience in the digital realm, with the natural rules that dictate our behavior in the real world.

It's more than a typical social network. Hibe is a social engine that brings reality into the digital realm with natural rules. Hibe does not drop users within a pre-built network. Hibe let users build their own network based on their real life connections. Of course, users may share connections (for example, a friend or an interest) with others, but others people will only have access to a user social environment on permission-based. This way, Hibe eliminates any prying eyes a user want to keep out of his/her private life or activities, online and offline.

In social interaction, people's perception of the identity of a person is mediated by the personal viewpoint of those people. In order to control the impressions other people form of them, users of a social network may only grant selective access to their profile information according to the relationship with the observer, from the perspective of the profile owner. Some embodiments in accordance with the present teachings provide a unique interaction framework, which includes the user's identity and his various relationship types with elements of his environment (or social objects).

### A—the User Identity

The identity is the core element of any social network. It is whatever makes the user definable and recognizable, in terms of possessing a set of qualities or characteristics that distinguish him from others. For institutions & corporate entities, the corporate identity is the “persona” of a corporation which is usually visibly manifested by way of branding and the use of trademarks. An important part of the user identity is how he views himself both as a person and in relation to other people.

In everyday's social interaction, impression management is the process through which the user will try to control the impressions other people form of him. The user will attempt to influence the perceptions of other people about his identity, by regulating and controlling information in his social interaction. For a corporate entities, brand identity is how these entities want the consumer to perceive the brand, and by extension the branded company, organization, product or service.

Using elements of his identity, the user creates subset-identities based on his relationships and a social context, and then request feedbacks that will help improve his image. This process is known in real as identity formation. Pieces of the individual's actual identity include a sense of continuity, a sense of uniqueness from others, and a sense of affiliation.

### Social Objects:

There is a need for one to express himself through his relations with social objects and provide an environment that will allow the user to describe these relations over a period time. In addition, using a database comprising elements of the environment, one can make list of social objects based on his preferences.

The benefit of using such a system is to be flexible enough to allow a user to identify himself, for example, through music, movies or any other social objects. Corporate entities will use for example their products, services, as social objects. Corporate entities can also use their brands which are a collection of symbols, experiences and associations connected with a product, a service, a person or any other artifact or entity, as social objects.

### B—User Relationships

Users behave differently depending with who they develop a relationship. As such, some embodiments based on the present teachings aim at providing an environment that can support a wide variety of relationship types. Additionally, some embodiments based on the present teachings aim at providing tools for users to customize their profile based on the relationship type.

### Relationship Types:

Users have various degrees of relationship in real life and some embodiments based on the present teachings aim at representing them in the community.

Some embodiments based on the present teachings tailor the user experience based on his various relationships. These may include: Friends, Family, Co-Workers, Groups, Fans & Favorites, Public, or any other social interaction context.

An exemplary advantage that is obtained with some embodiments based on the present teachings is the ability of using the relationships to reflect real life interactions within the virtual world. Each relationship type is associated to a feature set that appropriately defines it.

### Relationship Customization:

Some embodiments based on the present teachings aim at providing the user with the necessary tools to model each relationship based on his real life interaction. Basically, the element of his profile and the activities on the platform are shared based on the user's preferences.

### Corporate Relations:

Corporations and institutions can participate in a value added relationship with individuals and consumers. Should the corporate entity have a proper communication plan, some embodiments based on the present teachings would aim at providing them with the necessary tools to establish contact and to nurture a social commitment from the social network member.

Some embodiments based on the present teachings use a front-door policy for this type of relationships integrating concept of permission marketing within for example a Fans/Followers relationship type.

In developing the above mentioned functionalities, Some embodiments based on the present teachings allow for moving forward to replicate in online communities, the real social behavior of Internet users. This invention also aims to recreate the ease and the natural aspects of social interactions.

### General System Features Overview

### I—Multi-Facet System

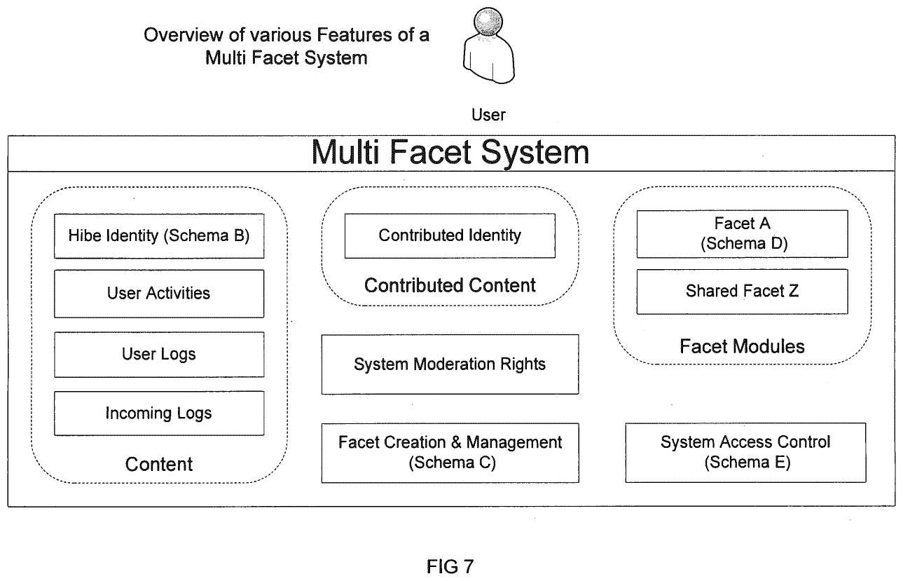

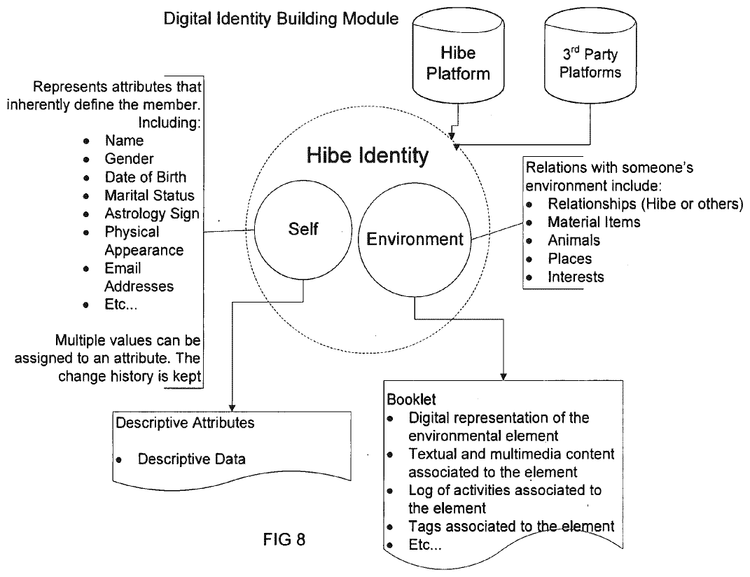

Referring to FIG. 7, an overview of various features of a multi-facet system is illustrated (hereinafter “HMFS or Hibe Multi-facet System”);

Hibe is a constituted name given in reference to the present invention when implemented over a social network.

Facet is defined as a subset-identity of a user; it reflects a given view or image (among a plurality of views) of the user.

HMFS is a system that manages the rights to access and export user-related content, as well as the rights to use features or to view information in a social context. The main components of the system are:

### User-Related Content:

It consists of the aggregation of all content related to the user including his identity from the Hibe Identity Module (see FIG. 8), all his activities and their logs on Hibe. The Content component also includes the activities and their logs on all booklets and profile attributes, the user automatically or manually subscribed to.

To illustrate the last point, a user may have asked to receive a feed (a stream of activity log) of the activities associated to the Grand Canyon, as he spent his honeymoon over there. Or he may automatically receive all new photos (activity) associated to the Honda Civic 1989, as he is using that digital symbol for one of his booklet.

### Contributed Content:

It consists of exported (“contributed”) elements of the User's Hibe Identity that are associated to a collaborative social context (“Shared Facet”).

It can include a copy of some of the user's booklets and of some of his descriptive data such as lists/albums, photos and videos.

The content is separated from the User-related Content as moderation rights may change to allow any members of the Shared Facet to modify or delete data from the content.

### Social Contexts (“Facets”):

Each facet represents a social context that includes privileges, including, access, interaction and administration rights to features and to both types of Content. A facet serves as a self-presentation of the user to others, aiming to influence the perception of his image. Thus, a facet is a perception management zone in which a user not only portraits a given identity of himself, but also includes a list of people he want to interact with by enabling them to access elements of such identity.

Each facet is a subset of your reality; and people you want to access such a facet are selected accordingly between a pool of peers (friends, colleagues, relatives, fans, dating mates, employers, complete strangers, etc.).

### Facet Creation & Management:

It consists of a component that allows a user to define his default image, the image he wants to project on each of his Facets, and the relations between his Facets.

### System Access Control:

It consists of the association between Facets and the User's contacts. The component manages the right to access each facet.

### System Moderation Rights

This component is not user-specific but system wide. It controls the moderation rights of facets when these are transferred to another user.

### II—Digital Identity Building Module

Referring to FIG. 8, an overview of a digital identity building module (hereinafter “HIM” or “Hibe Identity Module”) is illustrated.

HIM represents a process that captures data regarding a user, that organizes it manually or automatically and that displays it through a profile and its booklets.

### Capture:

The information that feeds the module comes from: (1) manually entered data from a user interface; (2) derived data by the system from the user's activities; (3) from a third party platform where the data was either entered or derived.

In order to manage the information, HIM will always try to take the information from the third party and annex it to its own. In some cases, it might be impossible. HIM will adapt and allow the management of the data as if it was on its own system.

### Manage:

HIM defines two types of user data.

A—Descriptive data (“Self”) that defines the user without specific relations with the outside world. Examples are: Name, Gender, and Weight, Date of birth, Email Address, Generic Photos, etc. These attributes are also referred to herein as intrinsic attributes.

B—Data related to the specific relations with social objects that defines the user. These include for example: the people he knows, the products he uses, the places he loves, the causes he advocates or his favorite pet. Such information is also referred to herein as extrinsic attributes.

HIM separately manages and stores Type A data and its changes as generic descriptive data.

HIM or the User creates booklets in which Him or the User inserts elements (also called social objects) of the Type B data.

Each booklet comprises: (1) a digital representation of the related element; that representation can be created by user, imported from a generic Hibe database, or imported from a third party platform; (2) the related data from the Capture process; (3) the log of activities related to that booklet element; (4) the manually entered or derived metadata to allow better booklet management; etc.

### Display:

In order to display the user's identity, HIM separates the descriptive data from the booklets giving each descriptive data and each booklet access rights that are managed by the Hibe Facets.

### III—Subset-Identity (Facet) Creation & Management

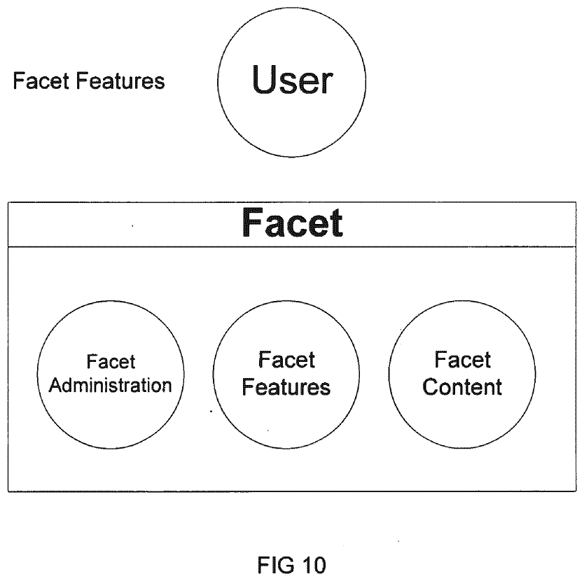

Referring to FIG. 10, an overview of a facet creation & management functionalities is illustrated.

A facet can be manually created by the User or auto-generated.

The system can automatically generate default facets based on generic relationships and contexts: for example “Friends Facet”, “Family Facet”, “Co-Workers Facet”, “Followers & Fans”; etc.

As facets represent the social contexts in which one can be seen, a user will always have at least one, his default.

Facets may be set in a hierarchical manner so that members of the parent facet are automatically granted access to the facet's children. Linking a non-shared facet to a shared facet is not considered hierarchical.

### IV—Subset-Identity (Facet) Structure

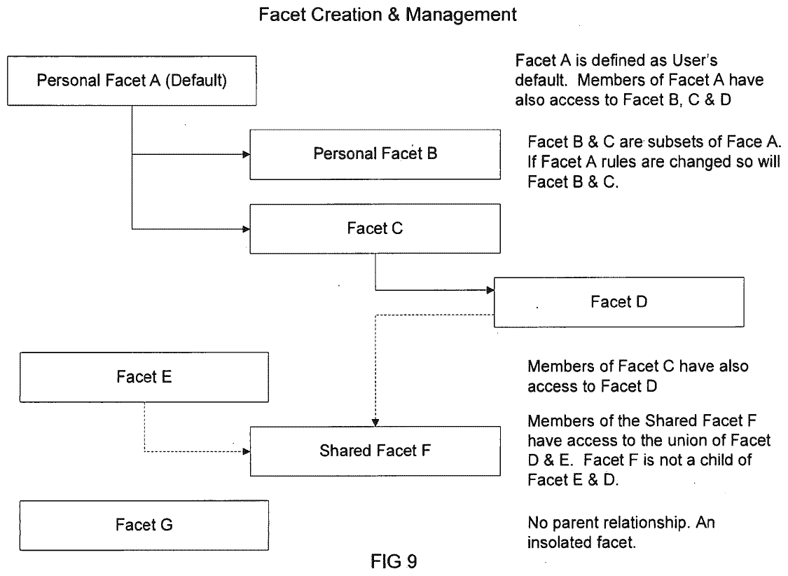

Referring to FIG. 9, an overview of a facet is illustrated.

A facet is a set of rules and rights that defines a given social context in which the user interacts with others. It comprises three components:

### 1) Administrative Rights

A facet can be shared among a group of individuals who will see it in their profile. If shared, all facet members will need to associate it with one or more “non-shared” ones. A shared facet possesses its own interface, otherwise it is the interface of the User's profile.

The administration components also contain the administrators of the facet. A facet may see its moderation rights transferred. If so, the moderation rights become managed by another module which can be the Moderation Rights Module outside the facet.

A facet may be visible or not. A visible facet tells about its existence but does not grant access.

### 2) Content Rules

Content rules define: a) designated elements of the Hibe Identity Module that the facet members can view; b) If shared, designated elements of the Hibe Identity Module that the facet members can view from the shared context; c) designated types of the User's activity-related data that the facet members can view; d) designated types of the User's activity-related data that will be pushed to the profile of each facet member; e) designated types of the facet members' activity-related data, the User wants to receive.

### 3) Feature Rights

This component provides the access rights to the various features of a facet. These are of two kinds: a) features related to the content of the facet, if any, such as “delete a shared content” or “comment on a photo”; b) features related to the overall context, such as “right to post a message”, or “right to post a photo”. It also includes the various communication features the facet members can use.

### V—System Access Control

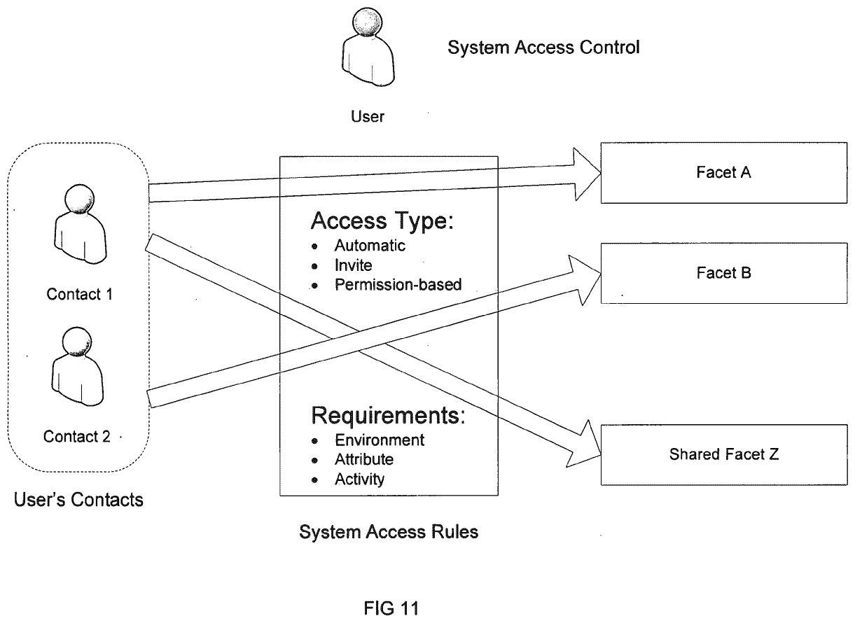

Referring to FIG. 11, an overview of a System Access Control is illustrated.

This module controls the rules of accessibility to each facet in control of the User.

An individual can be granted access to multiple facets of the User. Looking at the User's profile, the individual would see a single interface with the aggregated data and rights from the various facets he is a member of.

Facet access is managed through two variables: the access type that determines how a member is being granted access to a facet and the requirements that determines the prerequisites to receive such grant.

### A—Access Types

a) Access can be automatically granted to anyone who meets the requirements; b) access can be granted only if the facet administrator selects or invites the members individually; c) access can be granted on request only.

### B—Requirements

a) Access grant may be restricted based on the Hibe Identity of the members such as: i) Symbols used for Booklets (contacts, places, objects, animals, brand, cause, . . . ); ii) descriptive attributes such as age, gender, and education;

b) access grant may be restricted based on the activities of the members such as: i) facet membership (user must be a member of another facet of the administrator's profile); ii) activity level such as number of photos posted, number of products created, etc.

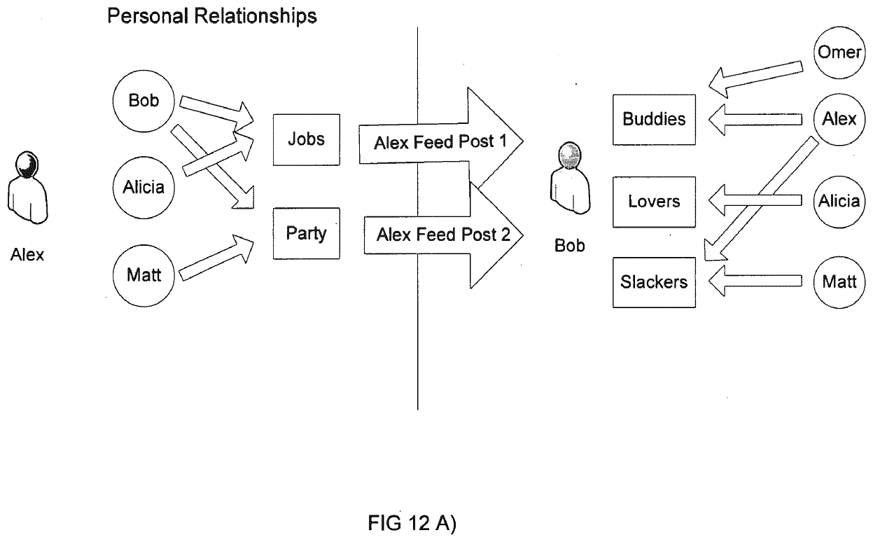

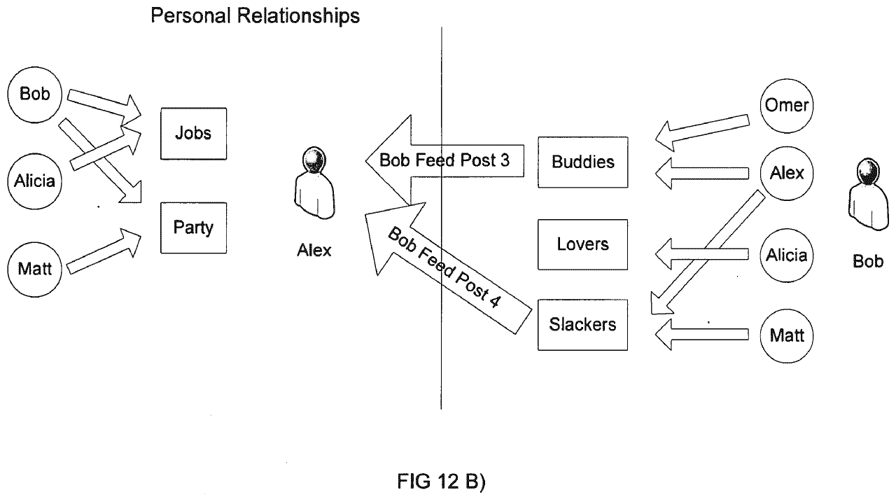

Referring to FIG. 12A) and B), personal relationship mapping based on facets is illustrated. First, referring to FIG. 12A), on Alex's profile: Bob views Party & Jobs aggregated profiles (Party∪Jobs), Alicia views Jobs profile, and Matt views Party profile.

On Bob's profile: Post 1 is viewed by Alex ((Slackers∪Buddies)∩(Jobs)+Alex), and Post 2 is viewed by Alex & Matt ((Slackers∪Buddies)∩(Party)+Alex);

Referring to FIG. 12B), on Alex's profile, Post 4 is viewed by Bob & Matt ((Jobs U Party)∩(Slackers)+Bob);

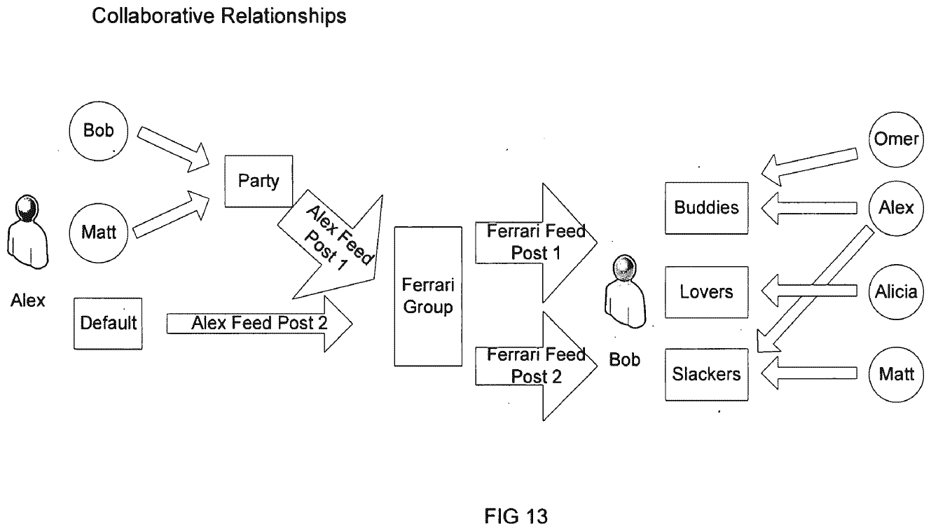

Referring to FIG. 13, collaborative relationship mapping based on facets is illustrated. On Alex's profile, Post 1 is viewed by Bob, Matt & Group Members, Post 2 is viewed by Alex's default privacy settings & Group Members.

On Bob's profile, Post 1 is viewed by (((Party∪Group)+Alex)∩(Buddies∪Slackers)), and Post 2 is viewed by (((Alex's Default∪Group)+Alex)∩(Buddies∪Slackers));

In the Ferrari Group, both posts can be viewed by group members;

### Exemplary Methods and Systems:

### I—Building a Digital Identity

Referring to FIG. 1, there is provided a method of building a digital identity of a user. The first step of the method consists of receiving profile attributes associated with a user 10. The profile attributes can be manually provided by the member, via a user interface 56 for example, or automatically collected from a local or remote database or device using an attribute collecting module 40 for example. The received attributes can be in any digital format, for example in a textual or a multimedia format. The profile attributes are stored in a first database 50.

The profile attributes are divided into intrinsic attributes and extrinsic attributes. The intrinsic attributes generally comprise static information about the member, information that is related to his own person, such name, address, age, profession, horoscope, gender, physical appearance, marital status, etc. In other terms, the intrinsic attributes inherently define the user.

Regarding the extrinsic attributes, it comprises information about social objects (also called elements of his environment) and about relations of the user with these social objects. A social object can be related to a material object, an animal, a person, a place, an event, a group of interest, etc.

The second step consists of generating a plurality of digital booklets comprising digital information associated with the received attributes 12. When the first step of receiving the attributes 10 is carried out separately in term of time of the second step of generating the booklets 12, the attributes are extracted from the first database 50 and are converted to a convenient digital format to be integrated in the booklets if required.

It should be understood by a person skilled in the art that each generated booklet is independent from the others in term of access and data continence, and that it can be constituted of one or more digital files. However, booklets may share the same intrinsic and extrinsic attributes associated to the user. Each generated booklet is associated with an identifier that uniquely identifies the booklet. The identifier can be a number, an alphabetical serial number, an alphabetical name or any other type of identifiers. In general, each booklet is related to a given aspect of the user, for example with a given social object among the social objects related to the user. The booklets are stored in a second database 52.

As an example, extrinsic attributes of a given user can comprise the following social objects: a house, a pet, a musical instrument and an employer. In this case, four different booklets can be generated, each booklet being related to a distinct social object. The booklet related to the house can comprise information reflecting the relation between the user and the house, such as a date of purchase, a picture of the house, a price of purchase, renovation experience, real estate agent identity and his picture, and any other information defining the experience history therebetween.

In another application, the booklet can be use for evaluation and rating purpose within an organization. Indeed, in the context of a SNS where an organization has all staff, employees can maintain a booklet on each supervisor to track periodic interaction with the said supervisor. Students can also do the same for professor. In both cases, these booklets can be sent to a superior entity of the supervisor or the professor for rating and evaluation purposes. This same process can be done by the employees for the organization of any pertaining entity of such an institution.

A further application of the booklets is in the field of commerce. For example, a user can maintain a booklet about his car, from the date his purchased the vehicle. Then, when come the day to sell the car, the booklet can be valuable sources of information that will help potential buyers learn about the history of such a car. Thus, updates done into the booklet associated to the car by previous owners will be transferred to the last buying party.

In the same way, the booklet related to the employer can comprise feedback about the employer, a rating of the employer by the user, and so on.

An application illustrating the utility of generating a booklet for the employer could be for automatically generating a rating of the employer using the information stored in the booklet. If a plurality of booklets associated with different users relate to the same employer, a rating of the employer based on the information provided by these various users through their corresponding booklets could be generated.

The booklets are generated according to booklet generating criteria that can dynamically be defined by the user using the user interface 56. The booklets can also be generated automatically using predefined booklet generating criteria stored in an accessible database. The process of generating the booklets could be triggered by the user through a user request comprising the booklet generating criteria.

The booklet generating criteria can consist of an identification of at least one social object among the social objects related to the user. In this case, the digital booklets are generated based on the at least one social object identified by said user, in such a way that every booklet related to a given social object contains all the information provided by the user in relation with the given social object.

The third step consists of updating the booklets over time 14. Since each booklet is independent from the others in term of data continence and data access, an accurate identification of the booklet to update is required. In the same optic, a cotenant update of a given booklet does not affect a cotenant of other booklets associated with the same user.

This process of updating the booklets can be carried out by the user or another authorized person.

The fourth step consists of tracking and cataloguing the booklets over time 16. The process of tracking and cataloguing the booklets over time can consist of tracking and cataloguing user's real life experience with the various social objects related to the generated booklets over time.

Generally, this step is automated and is triggered when the booklet is generated and each time the booklet is updated. The tracking and cataloguing process is carried out according to predefined tracking and cataloguing criteria. This criterion could be defined by the user or by the system administrator.

Data records associated with the tracking and cataloguing process are generated and are stored in a third database 54.

In a preferred embodiment, this method is computer-implemented and the steps 12, 16 and 18 are automated.

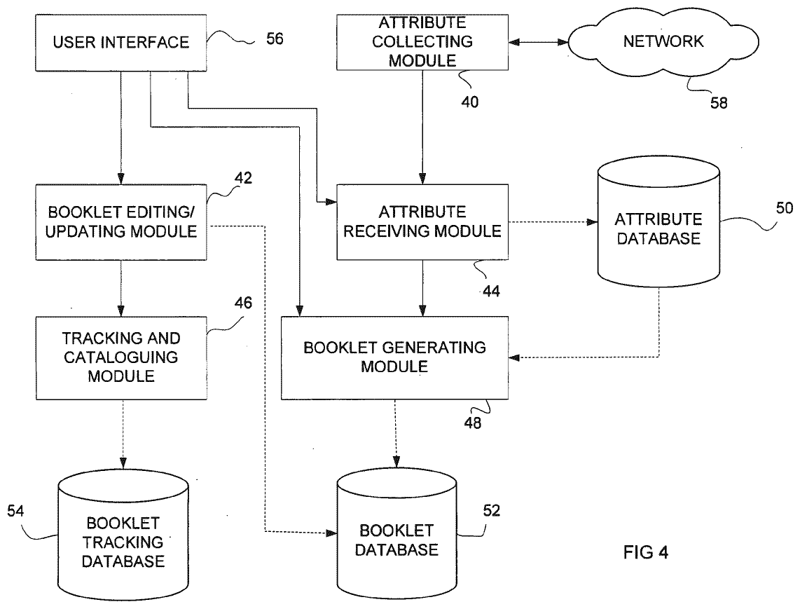

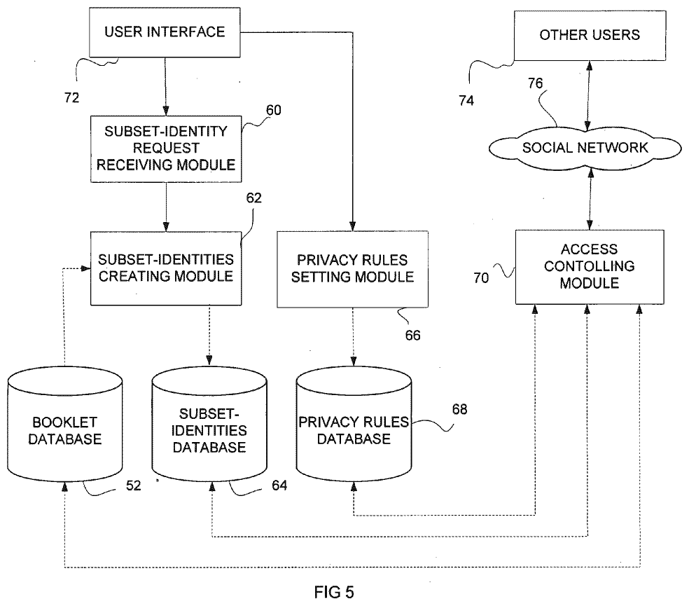

From a system perspective, referring to FIG. 4, there is provided a system for building a digital identity of a user. The system comprises a user interface 56, an attribute collecting module 40, an attribute receiving module 44, a booklet editing/updating module 42, a booklet generating module 48, a tracking and cataloguing module 46, an attribute database 50, a booklet database 52 and a booklet tracking database 54.

The attribute receiving module 44 is adapted for receiving profile attributes associated with the user. As mentioned hereinabove, the profile attributes comprise intrinsic attributes that inherently define the user and extrinsic attributes that comprise information about social objects and about relations therewith.

The attribute receiving module 44 is adapted to be connected to user interface 56 for enabling the user to manually upload the profile attributes. The attribute receiving module 44 is also adapted to be connected to an attribute collecting module 40 that is adapted to be connected to a data network 58 for automatically collecting the profile attributes from a local or remote database, device or interface connected to the data network 58.

The attribute receiving module 44 is further connected to an attribute database 50 for storing the received attributes.

The booklet generating module 48 is connected to the user interface 56 for receiving booklet generating criteria and to the attribute receiving module 44 for receiving a set of attributes, where the booklet generating module 48 is programmed for generating a plurality of digital booklets comprising digital information associated with the received attributes as a function of the booklet generating criteria.

The booklet generating module 48 converts the received attributes in a convenient digital format to be integrated into the booklets. The generated booklets are then stored in a booklet database 52.

It should be evident for a person skilled in the art that the process of receiving attributes by the attribute receiving module 44 and the process of generating booklets can be carried out separately in term of time frame. In this case, the attributes are already stored in the attribute database 50 when the booklet generating module 48 receives a request for generating booklets accompanied by the booklet generating criteria. The booklet generating module 48 retrieves appropriate attributes from the attribute database 50 based on the booklet generating criteria and then generates the digital booklets.

As mentioned, the booklet generating criteria can be defined by the user via the user interface 56 for example, or predefined and stored in storage means connected to the booklet generating module 48.

The social reality of a person is reflected by the intrinsic attributes of the person as well as by his interactions with the elements of his environment (social objects). Generally, each booklet reflects a distinct aspect of the user via his social objects that is represented by a booklet.

### II—Sharing a Digital Identity

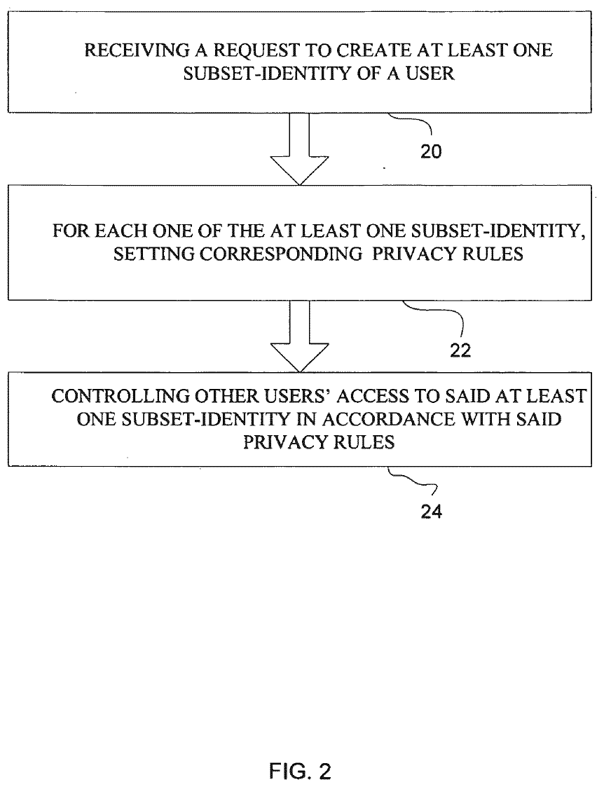

Referring to FIG. 2, there is provided a method for sharing a digital identity associated with a user. The first step of the method consists of receiving a request to create at least one subset-identity (also called facet) of the user, where each one of the at least one subset-identity is associated with at least one digital booklet containing digital information associated with attributes of the user 20.

According to a preferred embodiment, the method is computer-implemented over a social network.

The subset-identities (facets) can be organized according to various logical graphs. The facets can be logically organized in an isolated manner or in a hierarchical manner where each hierarchical facet is associated with a degree of intimacy, with the most personal profile on the top of the pile (highest degree of intimacy) and the less personal at the bottom (lower degree of intimacy).

A hierarchical organization of facets enables for carrying out interesting methods of managing the facets and securing intimacy violation by other users over social networks. For example, in a hierarchy organized facets, it can be defined that peers in an upper profile can have knowledge of the reality represented in the lower facet, but not the opposite.

In other terms, facets may be managed and connected with one another by a user to expose different identity to others. A user can create 2 types of facets structures: hierarchical facets and non-hierarchical facets that are also known as isolated facets.

The hierarchical facets are ordered by intimacy, with your most personal facet on the top and the less important at the bottom of the pile. You can promote or demote peers between such hierarchical facets depending on the intimacy and/or context of your relationship with them.

In hierarchy-based facets, peers in an upper facet have knowledge of your reality presented in the lower facet. Peers in any of your defined-profiles can see same-profile-mates, while peers in lower profiles won't have knowledge of friends in an upper facet.

Conversely to hierarchical facets, with non-hierarchical (or isolated) facets, you can create part of your reality that is only known by selected peers which are only part of each of these facets.

Thus, the isolated facets behave quiet differently from hierarchical facets where peers on a top-facet are aware of your reality represented in a profile facet at the bottom of the hierarchy.

As a method of implementation, users may also use a table containing his assets as rows and his facets as columns. Here, assets may include photos, videos, booklets, contacts, and collections of these elements. From this tableau the user may them check or uncheck the appropriate to associate or dissociate a given asset with a given facet. For example, Bob may associate Alicia to facet A and facet B by checking position P1 and P2. Bob can also associate Mat to facet B and facet C by checking position P6 and P9. Finally, Bob may also associate his booklet 1 about his boat with Facet B, and his booklet 2 about his son with facet C by checking positions P3 and P5. With this configuration Mat's view of Bob's profile will be different to Alicia's view of Bob's profile. Indeed, when visiting Bob's profile, Alicia will never find out that Bob has Mat as a friend, and Alicia will never find out that Bob's maintain a booklet about his Porsche.

According to this embodiment of the invention, by using the member interface 20, the member can associate with each one of the facets a correspondent degree of intimacy.

The subset-identities (facets) creating module 62 is adapted to be connected to a subset-identities database for storing therein data records associated with the plurality of subset-identities (facets) and with the correspondent associated degrees of intimacy if it is the case.

The second step consists of setting corresponding privacy rules for each one of the at least one subset-identity 22. The privacy rules are set by the user using the user interface 72.

The third step consists of controlling other users' access to the at least one subset-identity in accordance with the privacy rules set by the user 24.

The privacy rules generally comprise access privileges, interaction privileges and administration privileges.

The access privileges comprise information allowing for identifying users eligible for visualizing the digital information contained in the at least one digital booklet.

For example, an owner of a booklet may grant access to all or part of his booklet to others depending on the intimacy of the relationships with them. Thus, the owner of the booklet will only maintain one digital symbol while projecting different perceptions of its image through such an object. For example, let assume that Bob has a boat, and during one summer, he throw a party on his boat with old time friends that, Brenda, his girlfriend doesn't like. Bob can decide not to grant Brenda access to facts related to the party on his booklet associated to boat. Thus, the perception of the boat (which is part of Bob's reality) will be different for Bob's friends and Brenda, Bob's girlfriend. This is perception management (or is it lies?). Whatever it is call, this is a real life behavior and this embodiment of the invention shows how such an experience can be mimicked in the digital realm.

In this case, the access control process to the at least one subset-identity consists of, as a first step, determining users eligible to visualize information contained in the at least one digital booklet and, as a second step, of granting the eligible users access to visualize the at least one digital identity in accordance with the access privileges.

The method can comprise a supplementary step of setting hierarchical access rules between the at least two subset-identities for enabling eligible users granted access to a subset-identity of an upper level to be automatically granted access to one or more subset-identities of a lower level, and, if required, automatically granting the eligible users access to two or more subset-identities among the at least two-subset identities in accordance with the hierarchical access rules.

The interaction privileges comprise information allowing for identifying users eligible to interact with at least one other eligible user through the at least one digital booklet.

In this case, the access control process to the at least one subset-identity consists of, as a first step, determining users eligible to interact with at least one other eligible user through the at least one digital booklet and, as a second step, enabling the eligible users to interact with at least one other eligible user through the at least one digital booklet in accordance with the interaction privileges. The at least one digital booklet can be used as a mean of interaction or a subject of discussion.

In another scenario of social interaction, a user may be associated with a preferred facet, while being granted access to other facets within one's account. For example, Bob may choose to define a preferred context based on the level of intimacy of his relationship with others. In this case, Bob has set Facet A as the preferred context of interaction with Alicia. Thus, when visiting Bob's profile, Alicia will preferably see Bob's intrinsic attributes within the facet B, even thus Bob may have different intrinsic attributes within Facet B and Facet C. Additionally, Alicia may also have privileges inherited from facet A when interacting within Facet B and C. For example, Alicia may inherited editing rights from facet A even thus such right may not have been granted explicitly granted by Bob with Facet B and C.

The administration privileges comprise information allowing for identifying users eligible to carry out administration actions in connection with the at least one digital booklet.

In this case, the access control process to the at least one subset-identity consists of, as a first step, determining users eligible to carry out administration actions in connection with the at least one digital booklet and, as a second step, enabling the eligible users to carry out administration actions in accordance with the defined administration privileges.

The administration actions can consist of updating content of the at least one booklet, editing content of the at least one booklet, setting rules for receiving feeds through the at least one booklet and setting privileges to other users in connection with the at least one booklet.

As another scenario of social interaction, Alicia may want to include a special friend, Max, into given facets with her other friends. However, she might want to restrict some of her intrinsic attributes to Max. For example, Alicia may want to hide her birth date to Max to keep her age private. She may also want to hide or display another matrimonial status (Single, Divorced, etc.). With this invention, Alicia may choose to edit Max's access to her attributes, either from her list of contacts or from Max's profile page. This way, Max will only see limited or different intrinsic attributes of Alicia, conversely to her others friends.

The information allowing for identifying eligible users can be defined as a type or a group of eligible users or by identifiers allowing for uniquely identifying the eligible users (email address, name, phone, etc.).

In one embodiment, the method is implemented on a computer server connected to a social network, and the other users consist of users pre-registered on a database connected to the computer server or on another platform independent of the computer server.

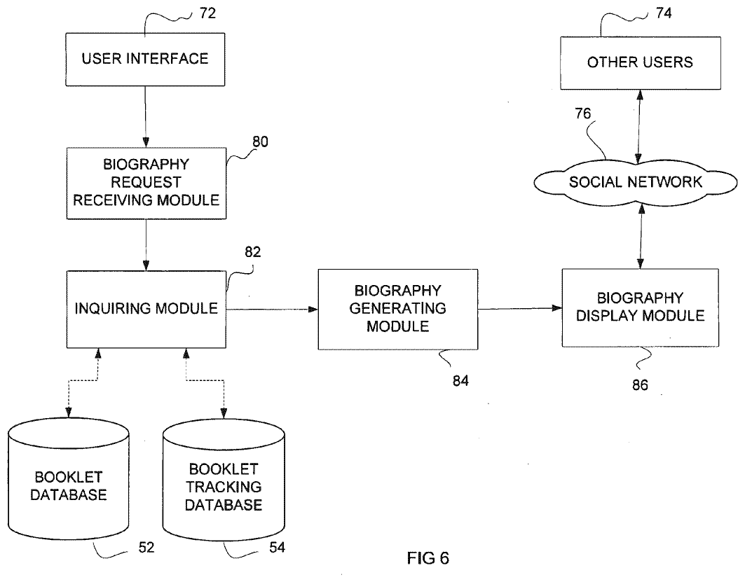

From a system perspective, referring to FIG. 5, there is provided a system for sharing a digital identity of a user. The system comprises: a user interface 72, a subset-identity request receiving module 60, a subset-identities creating module 62, a privacy rules setting module 66, an access controlling module 70, a booklet database 52, a subset-identities database 64 and a privacy rules database 68.

The subset-identity request receiving module 60 is adapted to be connected to the user interface 72 for receiving from a user a request to create at least one digital subset-identity. The request comprises information allowing for identifying at least one booklet to be associated with each one of the at least one subset-identity (facet) to create.

The subset-identities creating module 62 is connected to the subset-identity request receiving module 60, to a booklet database 52 and to a subset-identities (facets) database 64 for receiving the request, inquiring the booklet database as a function of the request, and for associating each one of the at least one subset-identity with at least one digital booklet stored in the first database 6. As mentioned hereinabove, the digital booklets contain digital information associated with attributes of the user. The subset-identities creating module 62 stores data records associated with the created subset-identities in the subset-identities database 64.

The privacy rules setting module 66 is connected to the user interface 72 for setting, for each one of said at least one subset-identity, corresponding privacy rules. As mentioned hereinabove, the privacy rules generally comprise access privileges, interaction privileges and administration privileges. The privacy rules setting module 66 is connected to the privacy rules database 68 for storing data records about the privacy rules.

The access controlling module 70 is connected to the booklet database 52, to the subset-identities database 64 and to the privacy rules database 68 and to a social network 76 for controlling other users' access to the at least one subset-identity in accordance with the privacy rules.

In one embodiment of the present invention, the access controlling module 70 receives a request from a given user 74 of the social network 76 to access, to administrate or to interact with at least one other eligible user via a given subset-identity (facet) of the first user. The access controlling module 70 inquires the privacy rules database 68 for determining if the given user is an eligible user as a function of the type of action required thereby. If the given user is eligible, the access controlling module 70 inquires the subset-identities database 64 to determine an identity of the at least one booklet associated with the given subset-identity, and enables the given user, as a function of the corresponding privacy rules, to access, administrate or interact with at least one other eligible user via the at least one booklet stored in the booklet database 52.

### III—Generating a Biography

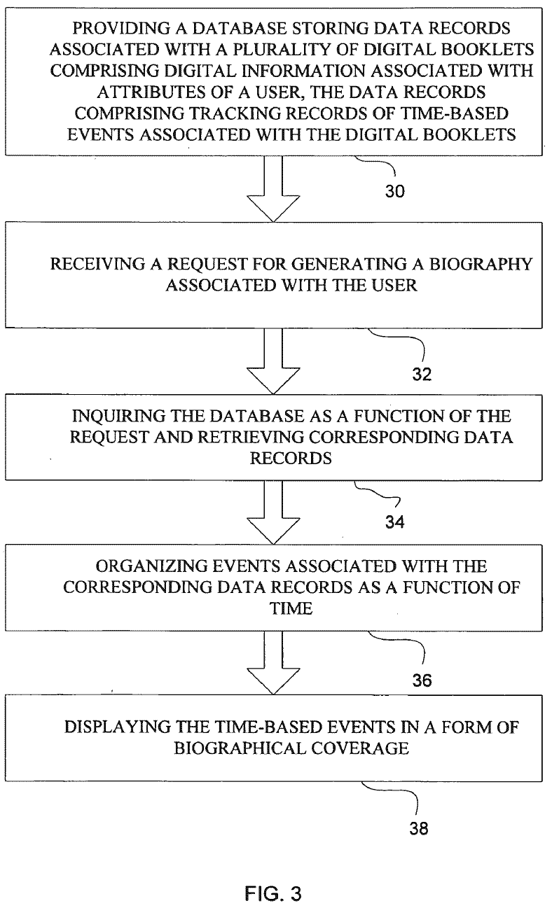

Referring to FIG. 3, there is provided a method of generating a biography associated with a user. The first step of the method consists of providing a booklet database 52 storing data records associated with a plurality of digital booklets comprising digital information associated with attributes of the user, where the data records comprise tracking records of time-based events associated with the digital booklets 30. The booklet database 52 and the booklet tracking database 54 are generally built according to the method of building a digital identity of a user described hereinabove. As mentioned hereinabove, the attributes comprise intrinsic attributes that inherently define the user and extrinsic attributes that comprise information about social objects and about relations of the user with social objects.

The second step consists of receiving at a computing device connected to the booklet database 52 a request for generating a biography associated with the user 32. The request should comprise information allowing for determining at least one booklet associated with the request and a time frame to be covered by the biography. This information could be an identification of a given social object belonging to the extrinsic attributes of the user.

The third step consists of inquiring the booklet database 52 as a function of the information embedded in the received request, and retrieving corresponding data records thereof 34. The corresponding data records are associated with at least one digital booklet determined in accordance with the information embedded in the request. If the request is related to given social object, the corresponding data records are then related to the given social object.

The fourth step consists of organizing events associated with the corresponding data records as a function of time 36.

The fifth step consists of displaying the time-based events in a form of biographical coverage 38.

In a preferred embodiment, the method is computer-implemented over a social network, and the steps 34, 36 and 38 are automated.

From a system perspective, there is provided a system for generating a biography associated with the user. The system comprises a user interface 72, a biography request receiving module 80, an inquiring module 82, a biography generating module 84, a biography display module 86, a booklet database 52 and a booklet tracking database 54.

As described hereinabove, the booklet database 52 stores data records associated with a plurality of digital booklets comprising digital information associated with attributes of a user. The booklet tracking database 54 stores tracking records of time-based events associated with the digital booklets.

The biography request receiving module 80 is connected to the user interface 72 for receiving a request for generating a biography associated with a user. The request comprises information allowing for determining at least one booklet associated with the request and a time frame to be covered by the biography. The user interface 72 allows users of the social network to manually define the request.

The inquiring module 82 is connected to the biography request receiving module 80, to the booklet database 52 and to the booklet tracking database for inquiring these databases as a function of the information embedded in the request and for retrieving corresponding data records thereof.

The inquiring module 82 is further connected to the biography generating module 84 for transmitting thereto the corresponding data records retrieved from the databases 52 and 54. The biography generating module 84 receives the corresponding data records, organizes events associated with the corresponding data records as a function of time and generates the biography.

The biography display module 86 is connected to the biography generating module 86 and to the social network 76 for displaying the time-based events in a form of biographical coverage.

As an example, friends and family members can maintain booklets about peers. Then, when comes a special event like birthday, marriage or any other celebration of a member, his friends can offer their digital booklet as a gift. Such offers will not only help the member leaning what other thing about him but also help him make adjustment to maintain his relationship with others. This can also be done to generate one's biography or perception according to others, or stories relative to objects in one's environment.

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

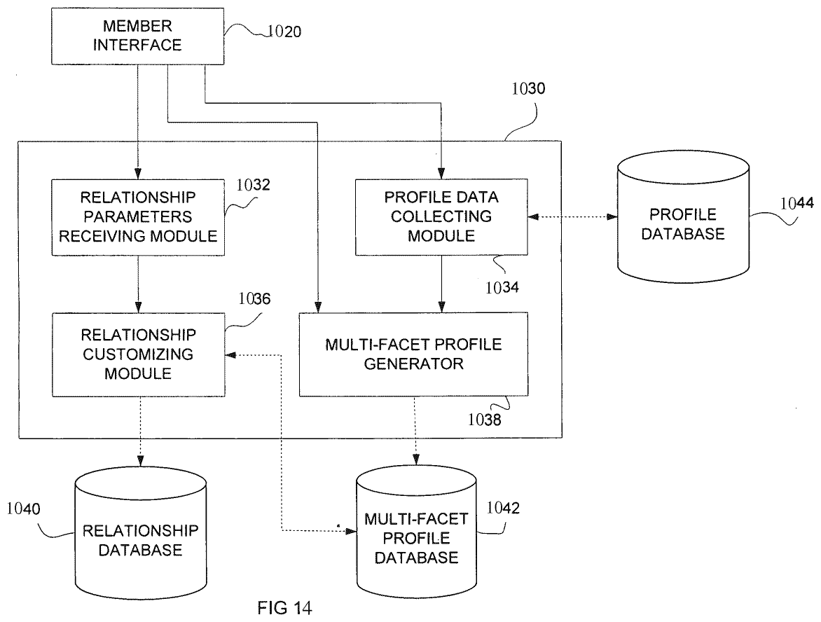

A second set of exemplary embodiments will be described with particular reference to FIGS. 14 to 23.

Some embodiments based on the present teachings further aim at providing solutions for users that concern themselves with how they look online, who looks at them and that want to receive feedback for the relations they establish with various material items of their environment.

### Advanced Social Network Functionalities:

Based on exemplary teachings of the present invention, a unique relationship framework has been created, which includes the user's identity and its various relationship types.

### A—The User Identity

The identity is the core element of any social network. It defines the user. Using his identity, he creates relationships and request feedbacks that will help improve his image.

### Material Relations

There is a need for one to express himself through his relations with material items and provide an environment that will allow the user to describe these relations over a period time. In addition, using a product database, one can make list of items based on his preferences.

The benefit of using such a system is to be flexible enough to allow a user to identify himself through music or movies.

### Implication

To be successful, the present technology using community requires a commitment from its members. From entering product information to uploading photos and videos, users participate in creating the generic value of the community. Such implication is rewarded as part of their identity.

### B—User Relationships

Users behave differently depending with who they develop a relationship. As such, some embodiments based on the present teachings aim at providing an environment that can support a wide variety of relationship types. Additionally, some embodiments based on the present teachings aim at providing tools for users to customize their profile based on the relationship type.

### Relationship Types

Users have various degrees of relationship in real life and Some embodiments based on the present teachings aim at representing them in its community.

Some embodiments based on the present teachings aim at tailoring the user experience based on these relationships. They are: Friends, Groups, Fans & Favorites, Public Profile.

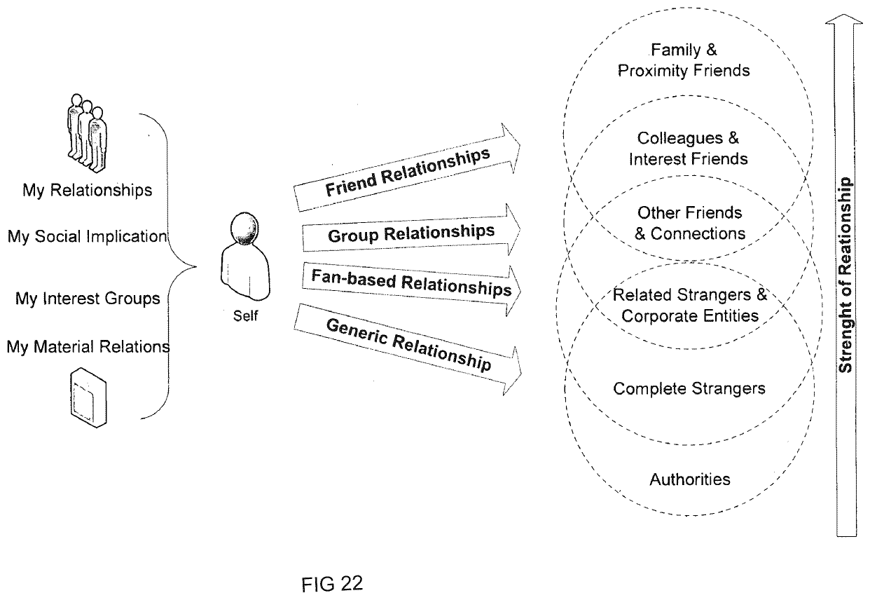

Some embodiments based on the present teachings provide the ability of using these relationships to reflect real life interactions within the virtual world. Each type is associated to a feature set that appropriately defines it (see FIG. 22).

### Relationship Customization:

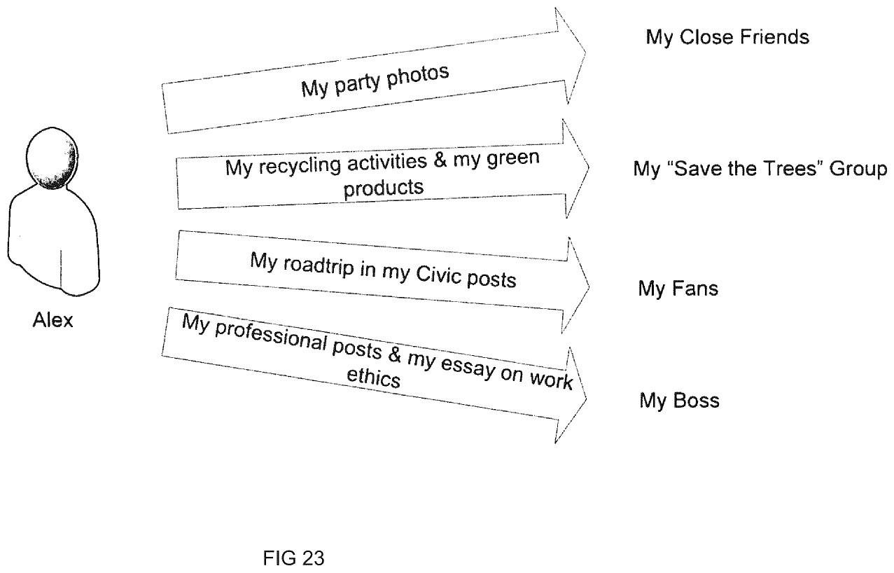

Not happy with the variety of relationship type, some embodiments based on the present teachings aim at providing the user with the necessary tools to model each relationship based on his real life interaction. Basically, the element of his profile and the activities on the platform are shared based on the user's preferences. FIG. 23 illustrates an example of the reality of a user named Alex's translated in accordance with some exemplary teachings of the present invention.

### Corporate Relations:

For many members of our society, companies can participate in a value added relationship. Should the corporate entity have a proper social marketing plan, some embodiments based on the present teachings aim at providing them with the necessary tools to establish contact and to nurture a social commitment from the social network member.

Some embodiments based on the present teachings use a front-door policy for this type of relationships integrating concept of permission marketing within the Fans/Followers relationship type. Tools such as crowdsourcing and demoing will be available.

### Subscription-Based Services:

If the social network features developed respond to most members, there are services that will satisfy only a small percentage of the that are developed as well. Some of these services are:

### StrongBox:

The StrongBox is an encrypted area of a users' profile where he can put data for non-sharing purposes. This data could be: Photos, Files, Product serial numbers & valuation for insurance purposes, Product purchase date & location.

Any content in a StrongBox is private, has a specific privacy agreement, is not counted toward user-created content in our statistics. This service tends to the need of having really private information completing the online environment of the user.

### Collections:

The Collections features allow a member to manipulate several products at the same time and to create checklists. It also allows him to add information to lists in order to present and manage his collections of items.

These collections are part of the identity of a user as he most likely spent several hours to build it. However, to upload it is tiresome and having these additional features will motivate him to do so.

### For Sale Inventory:

The For Sale features enable the member to add commercial information to the products in his profile. For example, if a student wants to sell some used school books, he could use the For Sale feature to sell them in one click.

### In General:

In developing the above mentioned functionalities, some embodiments based on the present teachings allow for moving forward to replicate in online communities, the real social behavior of Internet users. Future developments will also aim to recreate the ease and the natural aspects of these interactions.

### Exemplary System Description:

Referring to FIG. 14, there is provided a system for customizing a relationship between members of a social network based on a multi-facet member profile 1030. The system comprises a relationship parameters receiving module 1032, a profile data collecting module 1034, a relationship customizing module 1036 and a multi-facet profile generator 1038.

The profile data collecting module 1030 is adapted for receiving profile data associated with a first member of the social network. A person skilled in the art should understand that the profile data collecting module 1030 can be connected locally or remotely via a data network to any device, interface or database allowing for providing the profile data, such as a member interface 1020 or a profile database 1044.

The profile data can be manually provided by the member, via the member interface 1020 for example, or automatically collected from a local or remote database or device.

The profile data collecting module 1030 is connected to the multi-facet profile generator 1038 for transmitting thereto the collected profile data.

The multi-facet profile generator 1038 receives the collected profile data associated with the first member and segregates at least a part of the profile data into a plurality of identifiable profile facets. The segregation process can be carried out manually by the first member using the member interface 1020 for example, or automatically according to defined segregation criteria. The segregation criteria can be defined by the member via the member interface 1020 for example, or predefined and stored in storage means connected to the multi-facet profile generator 1038.

The social reality of a person is reflected by the intrinsic profile of the person as well as by his interactions with the elements of his environment. Generally, each segregated profile facet reflects a distinct aspect of the member profile that is preferably represented by a booklet.

The profile facets are divided into intrinsic profile facets and extrinsic profile facets. The intrinsic profile facets generally comprise static information about the member, information that is related to his own person, such name, address, age, profession, horoscope, gender, physical appearance, marital status, etc.

Regarding the extrinsic profile facets, each one discloses a relation of the member with an element of his environment, such as a material item, an animal, a person, a place, an event, or a group of interest.

The segregated profile facets can be organized according to various logical graphs. According to one embodiment of the invention, the facets are logically organized in a hierarchical manner, where each hierarchical profile facet is associated with a degree of intimacy, with the most personal profile on the top of the pile (highest degree of intimacy) and the less personal at the bottom (lower degree of intimacy).

A hierarchical organization of profile facets enables for interesting methods of managing the profile facets and securing intimacy violation of members over a social networks. For example, in a hierarchy organized profile facets, it can be defined that peers in an upper profile can have knowledge of the reality represented in the lower facet, but not the opposite.

According to this embodiment of the invention, by using the member interface 1020, the member associates with each one of the profile facets a correspondent degree of intimacy.

The multi-facet profile generator 1038 is adapted to be connected to a multi-facet profile database for storing therein data records associated with the plurality of identifiable profile facets and with the correspondent associated degrees of intimacy if it is the case.

The relationship parameters receiving module 1032 is adapted for receiving relationship parameters comprising: an identification of at least one other member of the social network, an identification of at least one profile facet among the identifiable profile facets, and sharing parameters defining access privileges to the at least one profile facet by the at least one other member.

A person skilled in the art should understand that the relationship parameters receiving module 1032 can be connected locally or remotely (via a data network) to any device, application, interface or database allowing for providing the relationship parameters, such as a member interface 1020 or a Web-based application allowing for selecting the at least one profile facet or the at least one other member from a list.

In one embodiment of the present invention, the relationship parameters receiving module 1032 allows said member to hierarchically identify the at least one profile facet by providing at least one of an indication of a given degree of intimacy and an identification of a given profile facet associated with the given degree of intimacy, where the at least one profile facet is deemed to include all profile facets associated with a degree of intimacy lower or equal to the given degree of intimacy among the plurality of profile facets.

The relationship customizing module 1036 is connected to the relationship parameters receiving module 1032 for receiving the relationship parameters and for generating, as a function of the relationship parameters, relationship data records comprising data records allowing for determining, for each one of said at least one other member, access privileges associated with each one of the at least one profile facet. The relationship customizing module 1036 is adapted to be connected to a relationship database 1040 for storing therein the generated data records.

A person skilled in the art should understand that the relationship customizing module 1036 can be connected locally or remotely (via a data network) to the relationship database 1040.

According to another embodiment of the present invention, the relationship parameters further comprise an identification of at least one interactional medium among a plurality of interactional mediums provided for use over a social data network, and use restriction parameters defining, for each one of the at least one other member, which medium he is allowed to use to interact with the first member or the first member's contacts.

The interactional mediums provided over the social network generally comprise text chatting, SMS messaging, email messaging, voice conferencing, and video-conferencing.

As an example of such an application, the first member can decide to allow a second member to interact with him using all of the available interactional mediums due to his high level of personal relation therewith, but to limit a third member to use only email messaging to interact with him due to his impersonal relation therewith.

In this case, the relationship customizing module 1036 further generates data records allowing for determining, for each one of the at least one other member, use privileges associated with each one of the at least one interactional medium in order to interact with the first member or his contacts.

According to a further embodiment of the present invention, the relationship parameters further comprise an identification of the first member's contacts over the social network and visibility parameters to be set between them and the at least one other member.

In other terms, while customizing his relation with a second member, the first member can decide who among his other contacts will be visualized by the second member.

In this case, the relationship customizing module 1036 further generates data records allowing for determining, for each one of the at least one other member, visibility privileges associated with each one of the member's contacts.

According to another embodiment of the present invention, the relationship parameters further comprise an indication if system-generated alerts associated with the first member are allowed or restricted to be transmitted to the at least one other member.

In this case, the relationship customizing module 1036 further generates data records allowing for determining, for each one of the at least one other member, transmitted alert privileges associated with the first member.

According to a further embodiment of the present invention, the relationship parameters further comprise an indication if system-generated alerts transmitted thereto and associated with the at least one other member are allowed or restricted.

This embodiment of the invention is to allow the first member to filter the received alerts from the other members of the social network.

In this case, the relationship customizing module 1036 further generates data records allowing for determining received alert privileges associated with each one of the at least one other member.

When all these embodiments of the invention are implemented in the same system, the relationship database 1040 would comprise:
A) data records allowing for determining, for each one of the at least one other member, access privileges associated with each one of the at least one profile facet;
B) data records allowing for determining, for each one of the at least one other member, use privileges associated with each one of the at least one interactional medium in order to interact with the first member or his contacts;
C) data records allowing for determining, for each one of the at least one other member, visibility privileges associated with each one of the first member's contacts;
D) data records allowing for determining, for each one of the at least one other member, transmitted alert privileges associated with the first member;
E) data records allowing for determining received alert privileges associated with each one of the at least one other member;

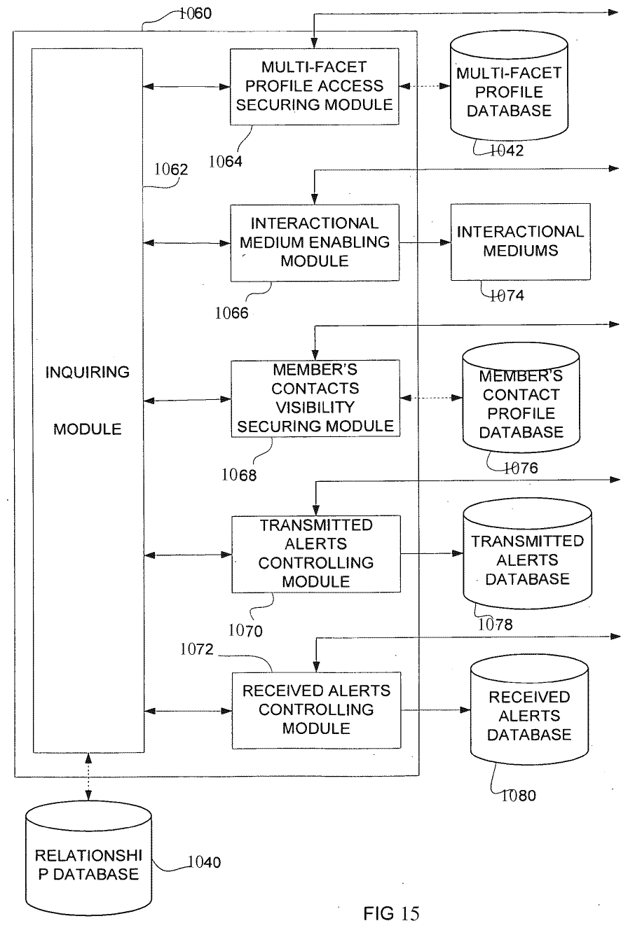

Referring to FIG. 15, there is provided a system for managing sharing of information over a social network 1060, the system comprising a relationship database 1040, an inquiring module 1062, a multi-facet profile access securing module 1064, an interactional medium enabling module 1066, a member's contacts visibility securing module 1068, a transmitted alerts controlling module 1070 and a received alerts controlling module 1072.

The relationship database 1040 comprises data records as described hereinabove.

The inquiring module 1062 is adapted to be connected to the relationship database 1040. The inquiring module 1062 receives an inquiring request from a given source module, inquires the relationship database 1040 as a function of parameters embedded in the received request, by generating and transmitting to the relationship database 1040 an inquiry compatible with the relationship database language (ex. SQL, etc.), receives inquiry results thereof, and generates and transmits an inquiring response to the source module.

The source module can be any of the multi-facet profile access securing module 1064, the interactional medium enabling module 1066, the member's contacts visibility securing module 1068, the transmitted alerts controlling module 1070 and the received alerts controlling module 1072.

The multi-facet profile access securing module 1064 is connected to the social network, to the inquiring module 1062 and to the multi-facet profile database 1042 comprising the plurality of profile facets of the first member. The multi-facet profile access securing module 1064 receives a request originating from the social network to access a given profile facet among the plurality of profile facets by a given member, generates and transmits an inquiring request to the inquiring module 1062 for inquiring if the given member is allowed to access the given profile facet, receives an inquiring response thereof, and if the inquiring response is positive, maps the given member to the given profile facet stored in the multi-facet profile database 1042.

A person skilled in the art should understand that the multi-facet profile access securing module 1064 can be connected locally or remotely (via a data network) to the multi-facet profile database. 1042.

The interactional medium enabling module 1066 is connected to the social network, to the inquiring module 1062 and to the plurality of interactional mediums 1074. The interactional medium enabling module 1066 receives a request originating from the social network to enable a given member to interact with the first member using a given interactional medium among the plurality of interactional mediums, generates and transmits an inquiring request to the inquiring module 1062 for inquiring if the given member is allowed to interact with said member using said given interactional medium, receives an inquiring response thereof, and if required, maps the given member to the given interactional medium.

A person skilled in the art should understand that the interactional medium enabling module 1066 can be connected locally or remotely (via a data network) to the plurality of interactional mediums 1074.

The member's contacts visibility securing module 1068 is connected to the social network, to the inquiring module 1062 and to a member's contact profile database 1076 storing profile data associated with contacts of the first member. The member's contacts visibility securing module 1068 receives a request originating from the social network to enable a given member to have a visibility of a given contact among the member's contacts, generates and transmits an inquiring request to the inquiring module 1062 for inquiring if the given member is allowed to have a visibility of the given contact, and if inquiring response is positive, maps the given member to the given contact.

A person skilled in the art should understand that the member's contacts visibility securing module 1068 can be connected locally or remotely (via a data network) to the member's contact profile database 1076.

The transmitted alerts controlling module 1070 is connected to the social network, to the inquiring module 1062 and to a transmitted alerts database 1078. The transmitted alerts controlling module 1070 receives a request originating from the social network to transmit a given system-generated alert associated with the first member to a given member of the social network, generates and transmits an inquiring request to the inquiring module 1062 for inquiring if the given system-generated alert is allowed to be transmitted to the given member, receives an inquiring response thereof, and if the inquiring response is positive, allows transmission of the given system-generated alert to the given member.

A person skilled in the art should understand that the transmitted alerts controlling module 1070 can be connected locally or remotely (via a data network) to the transmitted alerts database 1078.

The received alerts controlling module 1072 is connected to the social network, to the inquiring module 1062 and to the received alerts database 1080. The received alerts controlling module 1072 receives a request originating from the social network to allow reception of a given system-generated alert originating from a given member of the social network by the first member, generates and transmits an inquiring request to the inquiring module 1062 for inquiring if the given system-generated alert originating from the given member is allowed to be received by the first member, and if the inquiring response is positive, allows reception of the given system-generated alert by the member.

A person skilled in the art should understand that the received alerts controlling module 1072 can be connected locally or remotely (via a data network) to the received alerts database 1080.

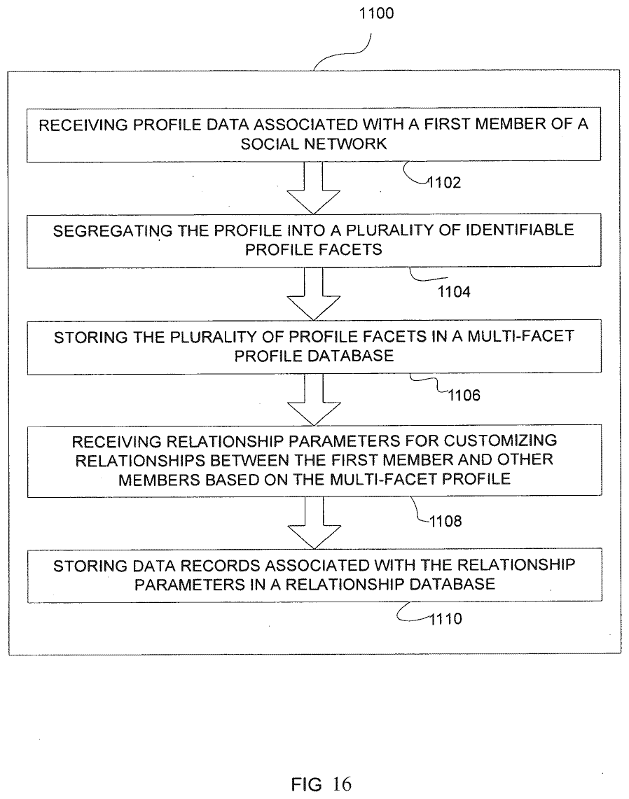

Referring to FIG. 16, there is provided a first embodiment of a method for customizing a relationship between members of a social network based on a multi-facet member profile 1100.

The first step consists of receiving profile data associated with a first member of the social network 1102. As mentioned hereinabove, a person skilled in the art should understand that the profile data can be collected (locally or remotely via a data network) from any device, application, interface or database allowing for providing the profile data, such as a member interface 1020 or a profile database 1044. The profile data can be manually provided by the member, via the member interface 1020 for example, or automatically collected from a local or remote database or device.

The second step of this method consists of segregating at least a part of the profile data into a plurality of identifiable profile facets 1104. The mechanism of the segregation process is detailed hereinabove.

The third step of this method consists of storing data records associated with the plurality of identifiable profile facets in a multi-facet profile database 1106.

The fourth step consists of receiving from the first member relationship parameters comprising: an identification of at least one other member of the social network, an identification of at least one profile facet among the identifiable profile facets, and sharing parameters defining access privileges to the at least one profile facet by the at least one other member 1108.

As mentioned hereinabove, a person skilled in the art should understand that the relationship parameters can be collected (locally or remotely via a data network) from any device, application, interface or database allowing for providing the relationship parameters, such as a member interface 1020 or a Web-based application allowing for selecting the at least one profile facet or the at least one other member from a list.

The fifth step consists of storing in a relationship database 1040, based on the relationship parameters, data records allowing for determining, for each one of the at least one other member, access privileges associated with each one of the at least one profile facet 1110.

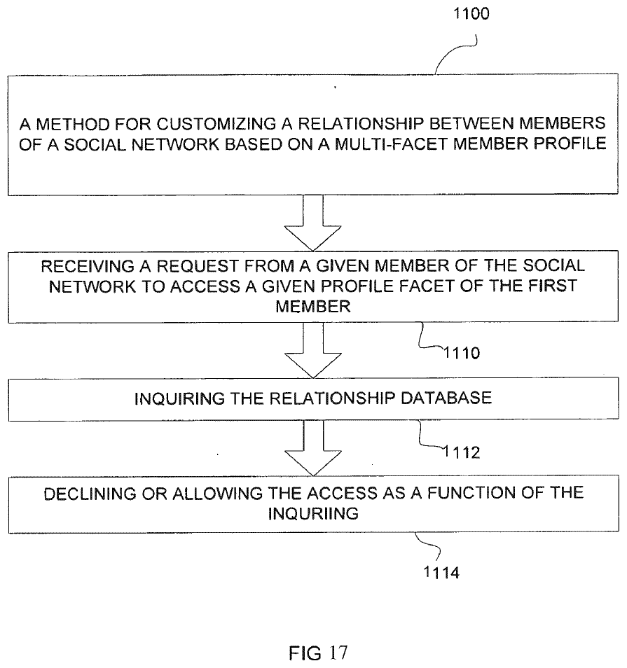

Referring to FIG. 17, there is provided a second embodiment of a method for customizing a relationship between members of a social network based on a multi-facet member profile 1100.

Once the relationship database 1040 based on multi-profiling is built, the next step consists of receiving a request from a given member of the social network to access a given profile facet of the first member 1110. Generally, the request comprises information allowing for determining an identity of the given member and the given profile facet he wishes to access.

Once the request is received, the further step consists of inquiring the relationship database 1040 for determining if the given member is allowed to access the given profile facet among said plurality of profile facets 1112.

And finally, as a function of the inquiring results, the last step according to this second embodiment consists of declining or allowing access to the given profile facet by the given member 1114.

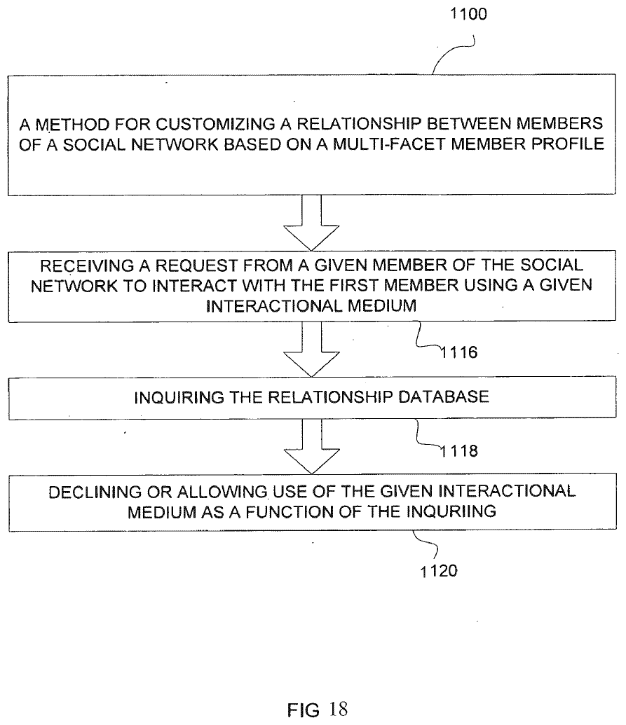

Referring to FIG. 18, there is provided a third embodiment of a method for customizing a relationship between members of a social network based on a multi-facet member profile 1100.

According to this third embodiment, after building the relationship database 1040, the first step consists of receiving a request from a given member of the social network to interact with the first member using a given interactional medium among the plurality of interactional mediums provided over the social network 1116.

The second step consists of inquiring the relationship database for determining if the given member of the social network is allowed to use the given interactional medium to interact with the first member or the first member's contacts 1118.

The third step consists of, as a function of the inquiring results, enabling or disabling the given member to interact with the first member using the given interactional medium 1120.

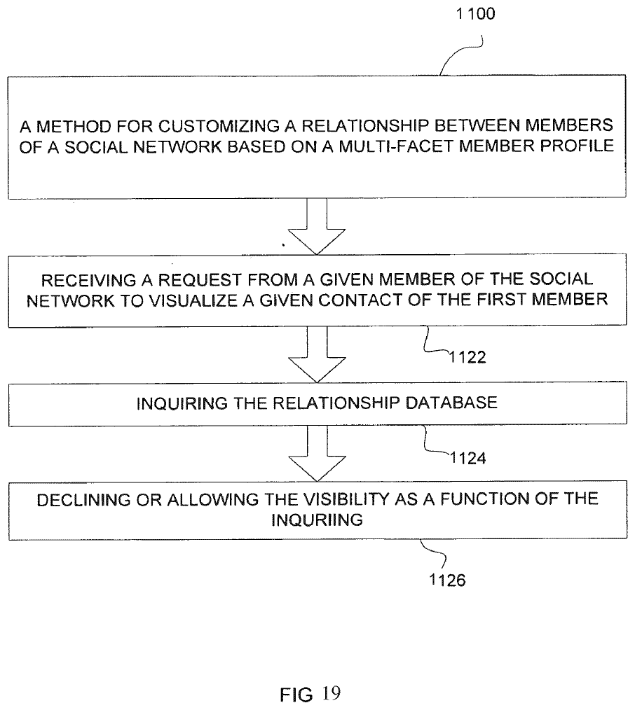

Referring to FIG. 19, there is provided a fourth embodiment of a method for customizing a relationship between members of a social network based on a multi-facet member profile 1100.

According to this fourth embodiment, after building the relationship database 1040, the first step consists of receiving a request from a given member of the social network to visualize a given contact of the first member 1122.

The second step consists of inquiring the relationship database for determining if the given member of the social network is allowed to have a visibility of the given contact among said member's contacts 1124.

The third step consists of, as a function of the inquiring results, declining or allowing visibility of the given member's contact to the given 1126.

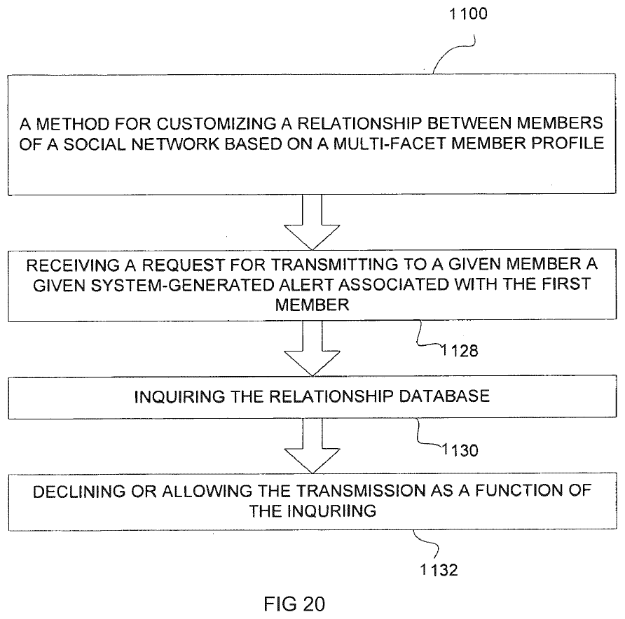

Referring to FIG. 20, there is provided a fifth embodiment of a method for customizing a relationship between members of a social network based on a multi-facet member profile 1100.

According to this fifth embodiment, after building the relationship database 1040, the first step consists of receiving a request for transmitting to a given member a given system-generated alert associated with the first member 1128.

The second step consists of inquiring the relationship database for determining for determining if the given system-generated alert associated with the first member is allowed to be transmitted to the given member of the social network 1130.

The third step consists of, as a function of the inquiring results, declining or allowing transmission of the given system-generated alert to the given member 1132.

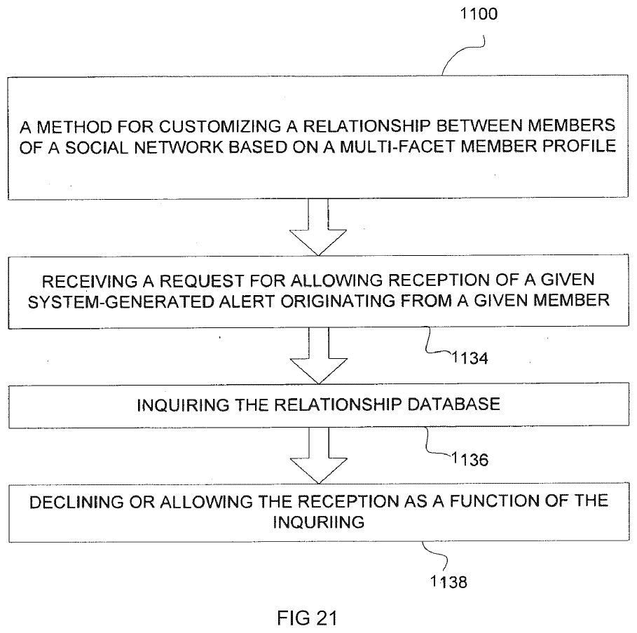

Referring to FIG. 21, there is provided a sixth embodiment of a method for customizing a relationship between members of a social network based on a multi-facet member profile 1100.

According to this sixth embodiment, after building the relationship database 1040, the first step consists of receiving a request for allowing reception of a given system-generated alert originating from a given member 1134.

The second step consists of inquiring the relationship database for determining for determining if the given system-generated alert originating from the given member of the social network is allowed to be received by the first member 1136.

The third step consists of, as a function of the inquiring results, declining or allowing reception of the given system-generated alert by the first member 1138.

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

As can be appreciated from the above, in some embodiments of the present invention, a facet represents a context of interaction and contains a subset-identity of it owner.

Contextual information within a given context comprises the context owner's identity and relationships associating the context owner with other parties. The contextual information may also comprise content (e.g., social objects) owned by the context owner and other parties who have access to the context.

For instance, context creation and storing may comprise the exemplary request 20 to create a subset-identity (context), where a subset-identity (context) is associated with at least one booklet (content) containing information associated with the user. Module 60 receives the request to create the subset-identity (context). The user interface 72 connected to the module is also for enabling the user to define manually the request 20. Module 62 associates a subset-identity (context) with a booklet (content). Database 64 stores data records about the subset-identity (context). Privacy rules 22 are set for the subset-identity (context). Module 66 sets privacy rules for the subset-identity (context). The user interface 72 connected to the module is for enabling the user to set manually the privacy rules corresponding to the subset-identity (context). Database 68 stores data records about the privacy rules corresponding to the subset-identity (context). FIG. 2, and FIG. 5 illustrate these modules and databases.

For instance, context accessibility comprises controlling other users' access to the subset-identity (context) according to the privacy rules associated to the subset-identity (context). Module 70 and databases 64, 68 are for controlling other users' access to the subset-identity in accordance to the corresponding privacy rules. An access control process to at least one subset-identity is provided. The system access control module represented in FIG. 11 controls the rules of accessibility to each facet. The system access control consists of the association between facets and the user's contacts.

A party identity can be represented as a facet or subset-identity. A facet is defined as a subset-identity of a user. It represents a given view or image (among a plurality of views or images) of the user. Identity creation and management can also be referred to as facet creation and management component as illustrated, for instance, in FIG. 7. It allows a user to define the image he wants to project on each of his facets. Some embodiments based on the present teachings further enable users to hide one or more facets while providing access to one or more other facets. Facet is a perception management zone in which a user includes a list of people he wants to interact with by enabling them to access elements of such an identity.

A relationship can be defined as information associated to people included in a facet (context). Users can associate people they want to interact with within each social context (aka facet). People who can access a facet are selected accordingly between a pool of peers (friends, colleagues, relatives, fans, dating mates, employers, strangers, etc.). The system access control illustrated in FIG. 7 consists of the association between facets and the user's contacts.

Relationship accessibility is illustrated, for instance, in FIG. 12-A and 12-B. A user's personal relationship can be mapped based on facets. Personal relationships mapping allow for controlling content accessibility and interactions accessibility between parties. The basic Facebook's common friends algorithm involving 3 parties in relationships is different from private relationship accessibility rule, through the example of Bob, Mat and Alicia.

Content may correspond to booklets, logs or activities. Booklets are digital symbols serving users to track their life experiences and interactions with others over time. Booklet information includes factual events, textual posts, multimedia content (photos, videos, sound). A booklet is an aggregated content (e.g., see FIG. 7).

Content association and storing allows users to associate booklets (content) with each social context (or facet). A process to associate a subset-identity (context) with a booklet (content) is also provided. Module 62 associates a subset-identity (context) with a booklet (content). The database 52 stores the booklets (content) comprising information associated to a user. An individual can be granted access to multiple facets of a user. When looking at the user's profile, this individual would see a single interface with the aggregated data from various user's facets he is a member of. FIG. 7 illustrates the multi-facet system (hereinafter HMFS). The HMFS manages the rights to access user related content, and the right to view information in a context. Content accessibility is a logic rule derived from applying the private relationship accessibility rule described herein. When a requesting party does not have access to the relationship information that associates the owner of the requested context and a second party within the requested context, it is normal that the requesting party is denied access to any content contributed within the requested context by the second party for privacy reasons. In addition, any contributions (e.g., child content) made by a third party on such a content owned by the second party should not be accessible to the requesting party, even if the requesting party has access to the relationship information between the owner of the requested context and the third party for the for the same privacy reasons.

The context, relationships, content, and identity accessibility define a set of privacy rules. Each subset-identity (context) has corresponding privacy rules. Privacy rules further comprise administration privileges allowing for identifying users eligible to carry out administration actions. Privacy rules also comprise information for controlling other users' access to the subset-identity (context).

Privacy rules further comprise interaction privileges information allowing for identifying users eligible to interact with another eligible user within the subset-identity (context). The booklet is one of a mean of interactions between eligible users allowed to access the context. Privacy rules further comprise access privileges information allowing for identifying party eligible for visualizing booklets (content) associated to a subset-identity (context). As described further herein, before allowing access to content within a sub-identity (context), the requesting party must have access to the said sub-identity (context).

A facet can be defined as a perception management zone in which a user includes a list of people he wants to interact with by enabling them to access elements of such an identity. The eligibility information or information allowing for identifying eligible users (relationship information) is associated to a context and can consist of user selection criteria comprising at least one type and a group of eligible users. The information allowing for identifying eligible users can also consist of predefined identifiers allowing for uniquely identifying the eligible users in accordance to a subset-identity (context). The types of relationships of the subset-identity owner as being friends, family, co-workers, groups, fans & favorites, public, or any other social interaction context.

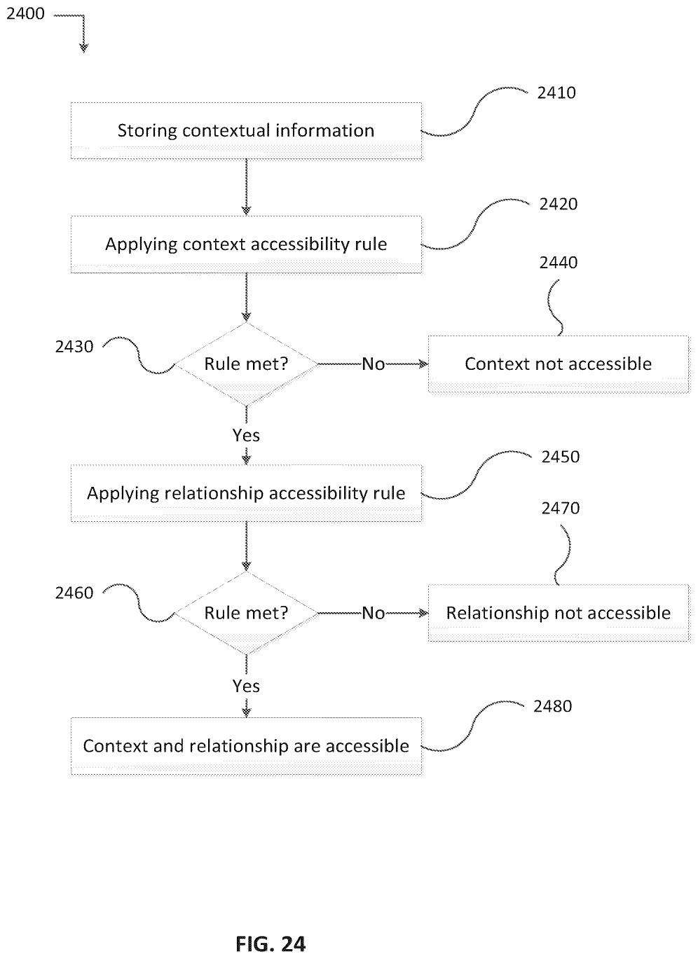

FIG. 24 shows an exemplary flow chart 2400 illustrating a computer implemented method in accordance with one embodiment of the present invention The method comprises storing the contextual information for a plurality of parties 2410. The contextual information, for each of the plurality of contexts, comprises a party identity that indicates a corresponding context owner and relationship information that associates the context owner with at least another party from the plurality of parties. The method also comprises, upon receipt of a request for access, by a requesting party from the plurality of parties, to contextual information from at least one requested context from the plurality of contexts, applying a context accessibility rule 2420. The context accessibility rule is met 2430 and the requested context is accessible to the requesting party when a corresponding relationship information from the requested context associates the requesting party with a corresponding context owner of the requested context. Otherwise, the requested context is not accessible 2440 to the requesting party.

The method then comprises, when the context accessibility rule is met, applying a private relationship accessibility rule 2450 to determine if the corresponding relationship information from the requested context associated to a first party of the plurality of parties is accessible to the requesting party. The relationship accessibility rule is met 2460 and the corresponding relationship information from the requested context associated to the first party is accessible to the requesting party 2480 if:
(i) there exists at least one context from the plurality of contexts owned by the first party in which the relationship information associates the first party with the requesting party and the first party with the context owner of the requested context; and
(ii) there exists at least one context from the plurality of contexts owned by the requesting party in which relationship information associates the requesting party with the first party and the requesting party with the context owner of the requested context.

Otherwise, the corresponding relationship information from the requested context is not accessible 2470.

Optionally, the contextual information from the requested context may further comprise content owned by at least a second party from the plurality of parties. In such an example, when the context accessibility rule is met, the method may further comprise applying a private content visibility rule whereby the content from the requested context associated to the second party is accessible to the requesting party when the corresponding relationship information from the requested context associated to the second party is accessible to the requesting party. The content from the requested context associated to the second party may further be a child content in a chain of dependent contents. In such an example, the child content from the requested context associated to the second party is accessible to the requesting party when each of the dependent contents in the chain is accessible to the requesting party. At least the content associated to the first party may further be associated to a further context from the plurality of contexts.

The method may also optionally comprise applying a private identity visibility rule wherein the party identity from the contextual information of the requested context is accessible to the requesting party when the requested context is accessible to the requesting party.

Each of the plurality of contexts may be defined as a representation of an environment with which at least one of the plurality of parties interacts and that is shared with other parties of the plurality of parties. A unique identifier may be provided for each of the plurality of contexts, the unique identifier being one of auto-generated or uniquely defined by the context owner of the corresponding context. The relationship information for each of the plurality of contexts may be a list of parties from the plurality of parties that are associated thereto. The content from the first party may be one of a photo, a video, a file, a text, or an aggregation thereof.

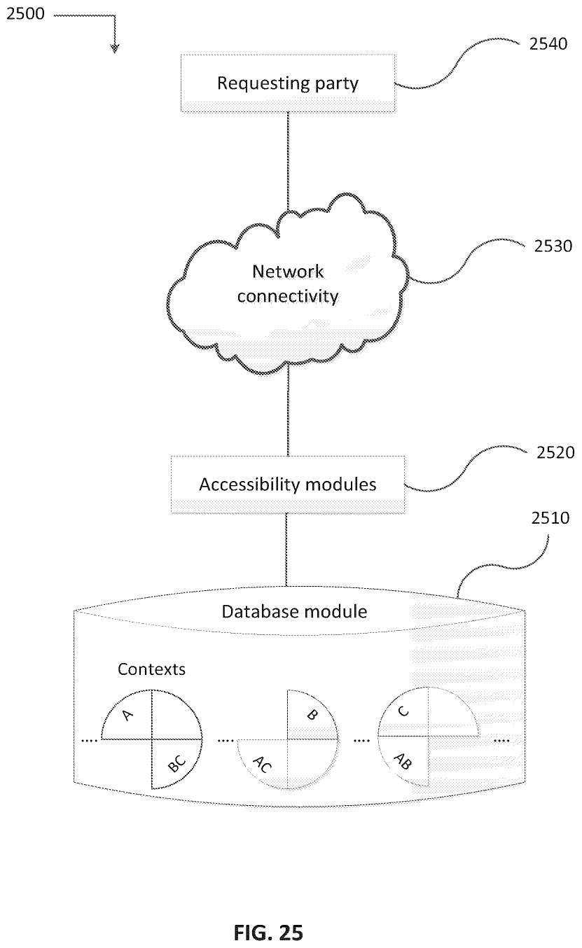

FIG. 25 shows an exemplary system 2500 for establishing, managing and displaying contextual information from a plurality of contexts. The exemplary system 2500 comprises a database module 2510 and accessibility modules 2520. Network connectivity 2530 is provided to a requesting party 2540.

The database module is for storing the contextual information for a plurality of parties. The database module may represent a single database, multiple databases (as illustrated in other figures) or any other storage means suitable for the purpose of the present invention. The contextual information, for each of the plurality of contexts, comprises:
(i) a party identity that indicates a corresponding context owner; and
(ii) relationship information that associates the context owner with at least another party from the plurality of parties.

The accessibility modules 2520 comprises a context accessibility module for, upon receipt of a request for access, by a requesting party from the plurality of parties, to contextual information from at least one requested context from the plurality of contexts, applying a context accessibility rule whereby the requested context is accessible to the requesting party when a corresponding relationship information from the requested context associates the requesting party with a corresponding context owner of the requested context.

The accessibility modules 2520 also comprises a relationship accessibility module for, when the context accessibility rule is met, applying a private relationship accessibility rule whereby the corresponding relationship information from the requested context associated to a first party of the plurality of parties is accessible to the requesting party when:
(i) there exists at least one context from the plurality of contexts owned by the first party in which the relationship information associates the first party with the requesting party and the first party with the context owner of the requested context; and
(ii) there exists at least one context from the plurality of contexts owned by the requesting party in which relationship information associates the requesting party with the first party and the requesting party with the context owner of the requested context.

Skilled persons will readily understand that reference to accessibility or visibility of the context, relationship, content or identity is meant to address the functionality by which privacy is maintained in accordance with one or more rule and that reference to visibility and/or accessibility rule is not meant to restrict the technical means by which such privacy is attained. Likewise, the embodiment(s) of the invention described above is(are) intended to be exemplary only. The scope of the invention is therefore intended to be limited solely by the scope of the appended claims.

1.-18. (canceled)

19. A system for automating context based access control and privacy control for an online social network, the system comprising:
an electronic database configured to store:
a plurality of facet records, each of the plurality of facet records comprising a unique facet identifier associated with each facet and a list of unique context identifiers associated with each facet and a list of users associated with each facet,
a plurality of context records, each of the plurality of context records comprising a unique context identifier associated with each context and a list of users granted access to each context, and
a plurality of booklet records, each of the plurality of booklet records comprising a unique booklet identifier associated with each booklet, each booklet record associated with content data; and
an electronic processing system comprising a computer server in communication with the electronic database and the online social network, the electronic processing system configured to:
generate a first booklet comprising a first content owned by a first user, the first content associated with a first context, the first context associated with a first facet owned by the first user,
grant visibility to the first content to a first list of users associated with the first context such that the first list of users can view the first content on their respective display devices,
receive a request from a second user to contribute a second content owned by the second user through a second facet owned by the second user, the second content associated with a second context, the second context associated with the second facet owned by the second user, the second content being a child-content of the first content owned by the first user, and
grant visibility to the second content to a second list of users associated with the second context, the second list of users determined by applying an intersection operator (∩) to a list of users associated with the second facet and the first list of users such that the second list of users can view the second content on their respective display devices.

20. The system of claim 19, wherein the electronic processing system is configured to:
receive a request from a third user to contribute a third content owned by the third user through a third facet owned by the third user, the third content associated with a third context, the third context associated with the third facet owned by the third user, the third content being a child-content of the second content owned by the second user, and
grant visibility to the third content to a third list of users associated with the third context, the third list of users determined by applying an intersection operator (∩) to a list of users associated with the third facet and the second list of users such that the third list of users can view the third content on their respective display devices.

21. The system of claim 19, wherein the electronic processing system is configured to receive a request from the first user to share the first content owned by the first user through the first facet.

22. The system of claim 21, wherein
the first facet is associated with a plurality of relationship types, and the request from the first user to share the first content includes a selection of one or more of the plurality of relationship types, and
the second facet is associated with a plurality of relationship types, and the request from the second user to contribute the second content includes a selection of one or more of the plurality of relationship types.

23. The system of claim 20, wherein the list of users associated with the second facet is selected by the second user and the list of users associated with the third facet is selected by the third user.

24. The system of claim 20, wherein the list of users associated with the second facet and the list of users associated with the third facet are electronically selected according to a predefined selection criteria.

25. The system of claim 24, wherein:
the list of users associated with the second facet is electronically selected by identifying the first user in the list of users associated with the second facet, and
the list of users associated with the third facet is electronically selected by identifying the second user in the list of users associated with the third facet.

26. The system of claim 25, wherein the second facet is associated with a plurality of sets of users and the list of users associated with the second facet is electronically selected based on identifying the first user in at least one of the plurality of sets of users associated with the second facet.

27. The system of claim 25, wherein the third facet is associated with a plurality of sets of users and the list of users associated with the third facet is electronically selected based on identifying the second user in at least one of the plurality of sets of users associated with the third facet.

28. The system of claim 20, wherein at least one of the list of users associated with the second facet and the list of users associated with the third facet is an aggregated list of users determined by applying a union operator (∪) to a plurality of sets of users.

29. A computer-implemented method for automating context based access control and privacy control for an online social network, the method comprising:
storing in an electronic database:
a plurality of facet records, each of the plurality of facet records comprising a unique facet identifier associated with each facet and a list of unique context identifiers associated with each facet and a list of users associated with each facet,
a plurality of context records, each of the plurality of context records comprising a unique context identifier associated with each context and a list of users granted access to each context, and
a plurality of booklet records, each of the plurality of booklet records comprising a unique booklet identifier associated with each booklet, each booklet record associated with content data; and
using an electronic processing system in communication with the electronic database and the online social network to:
generate a first booklet comprising a first content owned by a first user, the first content associated with a first context, the first context associated with a first facet owned by the first user,
grant visibility to the first content to a first list of users associated with the first context such that the first list of users can view the first content on their respective display devices,
receive a request from a second user to contribute a second content owned by the second user through a second facet owned by the second user, the second content associated with a second context, the second context associated with the second facet owned by the second user, the second content being a child-content of the first content owned by the first user, and
grant visibility to the second content to a second list of users associated with the second context, the second list of users determined by applying an intersection operator (∩) to a list of users associated with the second facet and the first list of users such that the second list of users can view the second content on their respective display devices.

30. The method of claim 29, wherein the electronic processing system:
receives a request from a third user to contribute a third content owned by the third user through a third facet owned by the third user, the third content associated with a third context, the third context associated with the third facet owned by the third user, the third content being a child-content of the second content owned by the second user, and
grants visibility to the third content to a third list of users associated with the third context, the third list of users determined by applying an intersection operator (∩) to a list of users associated with the third facet and the second list of users such that the third list of users can view the third content on their respective display devices.

31. The method of claim 29, wherein the electronic processing system receives a request from the first user to share the first content owned by the first user through the first facet.

32. The method of claim 31, wherein:
the first facet is associated with a plurality of relationship types, and the request from the first user to share the first content includes a selection of one or more of the plurality of relationship types, and
the second facet is associated with a plurality of relationship types, and the request from the second user to contribute the second content includes a selection of one or more of the plurality of relationship types.

33. The method of claim 30, wherein the list of users associated with the second facet is selected by the second user and the list of users associated with the third facet is selected by the third user.

34. The method of claim 30, wherein the list of users associated with the second facet and the list of users associated with the third facet are electronically selected according to a predefined selection criteria.

35. The method of claim 34, wherein:
the list of users associated with the second facet is electronically selected by identifying the first user in the list of users associated with the second facet, and
the list of users associated with the third facet is electronically selected by identifying the second user in the list of users associated with the third facet.

36. The method of claim 35, wherein the second facet is associated with a plurality of sets of users and the list of users associated with the second facet is electronically selected based on identifying the first user in at least one of the plurality of sets of users associated with the second facet.

37. The method of claim 35, wherein the third facet is associated with a plurality of sets of users and the list of users associated with the third facet is electronically selected based on identifying the second user in at least one of the plurality of sets of users associated with the third facet.

38. The method of claim 30, wherein at least one of the list of users associated with the first facet, the list of users associated with the second facet and the list of users associated with the third facet is an aggregated list of users determined by applying a union operator (∪) to a plurality of sets of users.

39. A computer-implemented method for automating context based access control and privacy control for an online social network, the method comprising:
storing in an electronic database:
a plurality of facet records, each of the plurality of facet records comprising a unique facet identifier associated with each facet and a list of unique context identifiers associated with each facet and a list of users associated with each facet,
a plurality of context records, each of the plurality of context records comprising a unique context identifier associated with each context and a list of users granted access to each context, and
a plurality of booklet records, each of the plurality of booklet records comprising a unique booklet identifier associated with each booklet, each booklet record associated with content data; and
using an electronic processing system in communication with the electronic database and the online social network to:
set a first hierarchical order of a plurality of facets owned by a first user, the first hierarchical order providing automated access in a higher-to-lower direction, and not in an opposite direction, with a list of users associated with the first user's higher level facet permitted access to the first user's lower level facet;
set a second hierarchical order of a plurality of facets owned by a second user, the second hierarchical order providing automated access in a higher-to-lower direction, and not in an opposite direction, with a list of users associated with the second user's higher level facet permitted access to the second user's lower level facet;
generate a first booklet comprising a first content owned by the first user, the first content associated with a first context, the first context associated with a first facet owned by the first user,
grant access to a second user to contribute a second content owned by the second user through a second facet owned by the second user, the second content associated with a second context, the second context associated with the second facet owned by the second user, the second content being a child-content of the first content owned by the first user, if:
(i) the first context or any further selected plurality of contexts owned by the first user based on the first hierarchical order includes at least one eligible first context in which a list of users granted access to the at least one eligible first context associates the first user with the second user; and
(ii) the second context or any further selected plurality of contexts owned by the second user based on the second hierarchical order includes at least one eligible second context in which a list of users granted access to the at least one eligible second context associates the first user with the second user;
grant visibility to the second content by applying a privacy rule based at least on the first hierarchical order applied to select a plurality of eligible first facets owned by the first user, the second hierarchical order applied to select a plurality of eligible second facets owned by the second user, and at least an intersection operator (∩) applied to a list of users associated to the plurality of eligible first facets owned by the first user and a list of users associated to the plurality of eligible second facets owned by the second user;
grant access to a third user to contribute a third content owned by the third user through a third facet owned by the third user, the third content associated with a third context, the third context associated with the third facet owned by the third user, the third content being a child-content of the second content owned by the second user, if:
(i) the first context or any further selected plurality of contexts owned by the first user based on the first hierarchical order includes at least one eligible first context in which a list of users granted access to the at least one eligible first context associates the first user with the third user and associates the first user with the second user; and
(ii) the third context or any further selected plurality of contexts owned by the third user based on a third hierarchical order includes at least one eligible third context in which a list of users granted access to the at least one eligible third context associates the third user with the first user and associates the third user with the second user.
